(19) United States
(12) Patent Application Publication
(10) Pub. No.: US 2011/0216411 A1
(43) Pub. Date: Sep. 8, 2011

(54) PATTERNED SHEETING WITH PERIODIC ROTATED PATTERNED REGIONS

(76) Inventors: David Reed, (US); John Nelson, The Sea Ranch, CA (US)

(21) Appl. No.: 13/040,044

(22) Filed: Mar. 3, 2011

Related U.S. Application Data
(60) Provisional application No. 61/311,088, filed on Mar. 5, 2010.

(51) Int. Cl. G02B 5/124

(52) U.S. Cl. 359/530

(57) ABSTRACT

In one embodiment of the invention, retro-reflective sheeting is disclosed. The retro-reflective sheeting comprises a flexible optical material film or substrate having a geometric optical surface opposite a base surface. The geometric optical surface includes a background pattern region of corner cubes arranged at a first orientation with respect to an edge of the retro-reflective sheeting; and an array of circular corner cube regions periodically interrupting the background pattern region of corner cubes. Each of the circular corner cube regions has a second orientation with respect to the edge of the retro-reflective sheeting. The array of the plurality of circular corner cube regions reflects incident light differently than the background pattern region of corner cubes.

### CROSS-REFERENCE TO RELATED APPLICATIONS

This non-provisional United States (U.S.) patent application claims the benefit of U.S. Provisional Patent Application No. 61/311,088 entitled MASTER TOOLS AND PATTERNED SHEETING WITH PERIODIC ROTATED PATTERNED REGIONS filed on Mar. 5, 2010 by David Reed et al., which is incorporated here by reference.

### FIELD OF THE INVENTION

The embodiments of the invention relate generally to patterned retro-reflective sheeting.

### BACKGROUND

Standards setting committees have been increasing the retro-reflective performance standards for various types of retro-reflectors, some of which apply to road signs, so that they are more visible at night. Some uniform patterns of corner cubes in retro-reflective sheeting may be unable to meet the more stringent retro-reflective performance standards. Other designs and patterns of corner cubes that can meet the requirements may be overly expensive to manufacture and use for road signs.

It is desirable to provide retro-reflective sheeting that can meet the more stringent retro-reflective performance standards at low costs so that it can be applied to road signs and such.

### BRIEF SUMMARY

The embodiments of the invention are best summarized by the claims that follow below.

### BRIEF DESCRIPTION OF THE DRAWINGS

FIG. 1A is a side view of a diagram illustrating a light reflector being irradiated by the light rays from a headlight lamp of an automobile, and the state in which the light reflected at the reflecting surface of the reflector is viewed by the driver.

FIG. 1B is a three dimensional illustration of a corner cube reflecting element of a light reflector.

FIG. 2A illustrates strips of retro-reflector sheeting with different corner cube patters pieced together so that there is an overall improvement in range of incident angle and reflectivity.

FIG. 2B illustrates a caution sign with strips cut from the same retro-reflective sheet but with different reflectivity for the same incident light angle.

FIG. 2C illustrates a diagram of a truck with a pair of strips cut from the same retro reflective sheet but oriented orthogonal to each other.

FIG. 3A illustrates a top view of a master tool for forming replicas and manufacturing a pattern in sheeting.

FIG. 3B illustrates a perspective view of a rotatable button inserted into openings of the master tool to form circular pattern regions in patterned sheeting during its manufacture.

FIGS. 3C-3G are perspective views of different shaped rotatable buttons and corresponding openings in the top plate that receive the rotatable buttons.

FIG. 4 illustrates a perspective view of an optional sleeve that may be placed over a rotatable button and inserted into openings of a master tool to form sealing structures in a patterned sheeting during its manufacture.

FIG. 5A illustrates a magnified top view of a corner of a master tool with a corner cube pattern cut into surfaces.

FIG. 5B is a schematic diagram illustrating the different orientations of the circular corner cube regions in comparison with the background corner cube regions.

FIG. 5C is a magnified top view of the corner of the master tool shown in FIG. 5A with the rotatable buttons turned so that the circular corner cube regions have a different orientation in comparison with the background corner cube regions.

FIG. 5D is a cross section view of a portion of the master tool shown in FIG. 5C across a diameter of a rotated button and circular corner cube region.

FIG. 5E is a cross section view of a portion of the master tool shown in FIG. 5A across a diameter of a rotated button and circular corner cube region.

FIG. 6A illustrates a magnified top view of a corner of a master tool with a corner cube pattern cut into surfaces and a ring around circular corner cube regions.

FIG. 6B is a schematic diagram illustrating the different orientations of the circular corner cube regions in comparison with the background corner cube regions.

FIG. 6C is a magnified top view of the corner of the master tool shown in FIG. 6A with the rotatable buttons turned so that the circular corner cube regions have a different orientation in comparison with the background corner cube regions.

FIG. 6D is a cross section view of a portion of the master tool shown in FIG. 6C across a diameter of a rotated button and circular corner cube region.

FIG. 7A is a top view of retro-reflective sheeting manufactured with a plurality of rectangularly aligned replicas formed out of the master tool shown in FIG. 6C.

FIG. 7B is a top view of retro-reflective sheeting manufactured with a plurality of diagonally aligned replicas formed out of the master tool shown in FIG. 6C.

FIG. 7C is a magnified top view of a corner of the retro-reflective sheeting shown in FIG. 7A illustrating a sealing ring pattern and the circular corner cube regions having a different orientation in comparison with the background corner cube region.

FIG. 7D is a cross section view of a portion of the retro-reflective sheeting shown in FIG. 7C across a diameter of the circular corner cube region.

FIG. 7E is a cross section view of a portion of the retro-reflective sheeting shown in FIG. 7E along a groove in the circular corner cube region extending into the background corner cube region.

FIG. 8A is a top view of retro-reflective sheeting manufactured with a plurality of rectangularly aligned replicas formed out of the master tool shown in FIG. 5A.

FIG. 8B is a magnified top view of a corner of the retro-reflective sheeting shown in FIG. 8A illustrating the circular corner cube regions having a different orientation in comparison with the background corner cube region.

FIG. 8C is a cross section view of a portion of the retro-reflective sheeting shown in FIG. 8B across a diameter of the circular corner cube region.

FIG. 9 is a cross section view of a portion of a retro-reflective sheeting across a diameter of its circular corner cube region with a pattern of corner cubes formed so that their peaks are lopped off by ten to twenty percent of their heights.

FIG. 10A is a top plan view of the design for the ring seal pattern on the retro-reflective sheeting, it being understood that the ring seal pattern is substantially uniform repeating over the length and width of the retro-reflective sheeting.

FIG. 10B is a side elevational view of the design for the ring seal pattern on the retro-reflective sheeting.

FIG. 10C is a cross-sectional view of the design for the ring seal pattern on the retro-reflective sheeting.

FIG. 10D is a cross-sectional view of the design for the ring seal pattern on the retro-reflective sheeting.

FIG. 11 is a top magnified view of the design for a corner cube surface pattern on the retro-reflective sheeting.

FIG. 12A is a top magnified view of the design for corner cube surface pattern on the retro-reflective sheeting having orthogonal circular corner cube regions and a circular sealing ring of an alternate embodiment.

FIG. 12B is a top magnified view of the design for corner cube surface pattern on the retro-reflective sheeting having orthogonal circular corner cube regions of a first embodiment.

FIG. 13 is a perspective view of machine for forming a pattern into the surfaces of the master tooling.

FIG. 14A is a cutaway view of an exemplary electro-plating bath to illustrate the electro-formation of a replica from the master tooling.

FIG. 14B is a cross sectional view of the replica formed in FIG. 14A separated from the master tooling in the exemplary electro-plating bath.

FIG. 15 illustrates a schematic diagram of a plurality of replicas positioned together in a loop to continuously manufacture rolls of retro-reflective sheeting.

FIG. 16 illustrates a schematic diagram of an exemplary manufacturing system for manufacturing of a roll of retro-reflective sheeting using the plurality of replicas positioned together in a loop.

FIGS. 17A-17B are exploded side views of other layers and their orientation that may be laminated together with the retro-reflective film.

FIG. 18 is a perspective view of an exemplary roll of retro-reflective sheeting.

Like reference numbers and designations in the drawings indicate like elements providing similar functionality. The figures are not drawn to scale so that elements, features, and surface structure may be shown by example and are intended merely to be illustrative and non-limiting of embodiments of the invention claimed.

### DETAILED DESCRIPTION OF THE INVENTION

In the following detailed description of the embodiments of the invention, numerous specific details are set forth in order to provide a thorough understanding. However, it is to be understood that the embodiments of the invention may be practiced without these specific details. In other instances, known methods, procedures, elements, components, and equipment have not been described in detail so as not to unnecessarily obscure aspects of the embodiments of the invention.

### Introduction

Reflectors may use an array of ball or spherical lenses formed out of an optical material to reflect incident radiation such as light. In other cases, a reflector may use an array of truncated corner cubes formed out of an optical material to reflect incident radiation. In other instances, a reflector may use an array of full corner cubes formed out of an optical material to reflect incident radiation.

Full corner cubes tend to be more reflectively efficient than truncated corner cubes. However, full corner cubes are more difficult to manufacture. Generally a reference to corner cubes herein is referring to truncated corner cubes.

Typically, retro-reflective sheeting or film for reflectors is formed out of a thin plastic or optical material film that is transparent to desired wavelengths of electromagnetic radiation (typically the visible light spectrum). The optical material film has a base surface and a top surface, The top surface has a tiled top surface pattern transferred to it from that of a master tool. The base surface of the retro-reflective sheeting is typically a flat surface of the optical material film that receives incident light and launches the reflected light. The top surface with the tiled top surface pattern has the truncated corner cube pattern that naturally reflects incident light at a pre-determined incident angles. Typical methods of manufacturing an array of truncated corner cubes into a reflective sheeting or film are by molding, stamping, or embossing processes.

The molding process typically requires one or more dies or molds which are fixed for a given pattern. A plastic, acrylic, or other similar optical material in liquid or molten form, with a desired index of refraction, is poured over and into the dies or molds. The optical material requires a curing time in the dies or molds in order to take a shape which has reflective properties.

A stamping process typically requires one or more rectangular stamps or dies which have a fixed pattern are used. A soft semi-solid or semi-liquid optical material, such as plastic with a desired index of refraction, is stamped by the stamp into a shape which has reflective properties. Retro-reflective sheeting with corner cube patterns may be used in different applications.

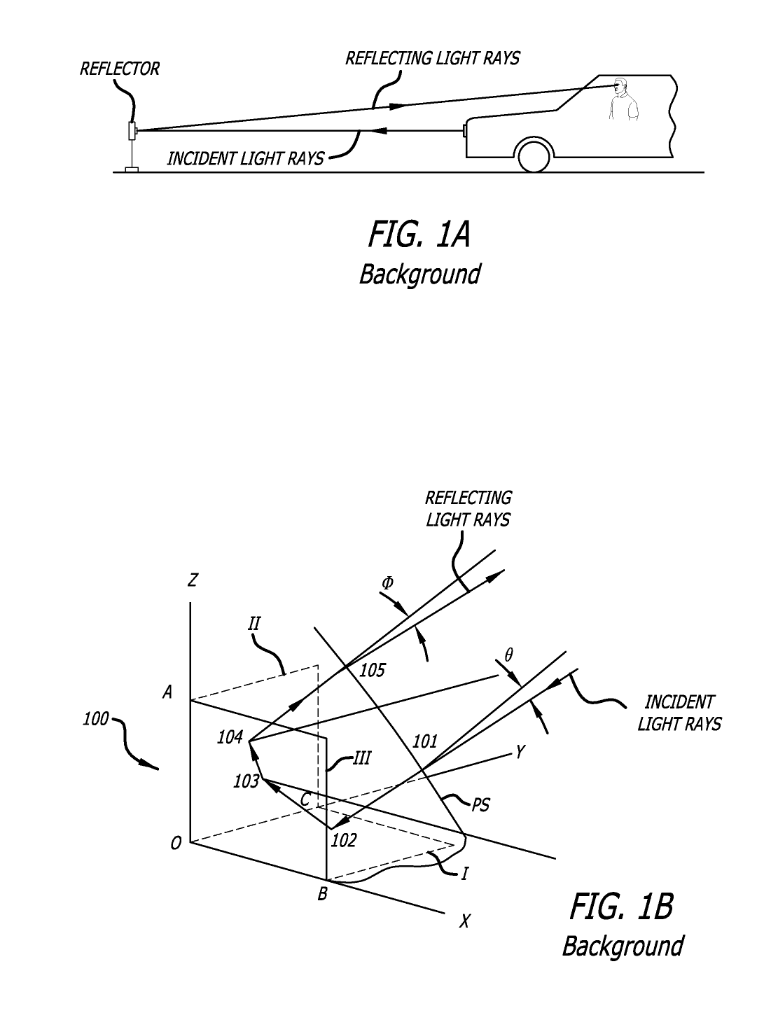

Referring now to FIG. 1A, a light reflector for reflecting light receives incident light rays at an incident angle from an external light source such as the headlight lamps of a vehicle or the like. The light reflector includes an array of a plurality of corner cube reflectors to reflect the incident light rays back at a different angle, an exit angle, so that eyes of a human such as a driver or passenger in a vehicle, can see the light reflected back from the reflector at night or in darkness. The light reflector may for example be, signal marks or caution marks, installed at one or both sides of a road to serve as signal or caution mark as shown. Alternatively, the light reflector may be affixed to the body of a truckable container, a truck, an automobile or other vehicle to alert a person to its presence and/or provide information about its size.

Referring now to FIG. 1B, operation of a corner cube element is now described briefly with reference to the retro-reflective sheeting 100. The sheeting and corner cube element is made from a translucent optical material that is translucent to a desired wavelength of electro-magnetic radiation and has an index of refractive that can provide a total internal reflection at desired angles of incidence. A refractive index around 1.5 or more for the optical material may be typical. The typical shape of corner cube reflecting element is a right-angled triagonal pyramid member. However, the right-angled triagonal pyramid member may slightly cantoned at an angle so it is merely a triagonal pyramid member to increase the angle of incidence over which the incident light rays are received.

In order to show the course of the changes in direction of the light rays within the retro-reflecting sheeting, assume that the apex of the pyramid of the corner cube is designated by origin O, a first reflecting plane (I) is defined by edge lines OC and OB; a second reflecting plane (II) is defined by edge lines OC and OA; and a third reflecting plane (III) is defined by edge lines OA and OB. It will be understood that the edge lines OA, OB and OC may be parallel with the optical axes Z, X and Y which cross each other at a substantial right angle, respectively.

Incident light rays strike a plane surface PS of the retro-reflective sheeting 100 at an angle of incidence Θ. Reflecting light rays exit the plane surface PS of the retro-reflective sheeting 100 at an exit angle Φ. The pattern of the corner cube in the retro-reflective sheeting 100 may be formed by the top surface of the master tool described herein.

The incident light rays are refracted at the plane surface PS and enter into the sheeting at an entry point 101 as refracted light rays. The refracted light rays are directed towards a first reflecting plane (I) of the corner cube as internal light rays. The internal light rays are reflected at the three reflecting planes (I), (II) and (III) of the corner cube, respectively.

At point 102, the internal light rays are reflected by the first reflecting plane (I) towards the second reflecting plane (II). At point 103, the internal light rays are reflected by the second reflecting plane (II) towards the third reflecting plane (III). At point 104, the internal light rays are reflected by the third reflecting plane towards an exit point at the plane surface PS. At the exit point 105 on the plane surface, the internal light rays are refracted and exit the retro-reflective sheeting at the exit angle Φ as the reflecting light rays. The detailed angles and mathematics of reflection and refraction of the light rays is explained in U.S. Pat. No. 3,817,596, issued on Jun. 18, 1974 to Tanaka which is incorporated herein by reference. U.S. Pat. No. 4,349,598 issued on Sep. 14, 1982 to White further describes the operation of a corner cube retro-reflector, which is also incorporated by reference.

The reflective sheeting 100 may include a plurality of truncated corner cubes. Each corner cube has a base edge (B), a tail (T), a head (H), a vertex or apex (A), and three facets or planar surfaces (S1, S2, and S3) at which light may be reflected. The apex, where the three planar surfaces (S1, S2, and S3) join together at a corner, is nearer the head of each corner cube. The tail of each corner cube is opposite the head. The base edge of each corner cube may be level with a base surface of the reflective film. Along a column, the base edge of one corner cube may join the base edge of the next corner cube. Each corner cube resembles a tetrahedron. That is, each corner cube resembles a triangular pyramid having three triangular sides and a triangular base. The triangular pyramid shape may or may not be symmetrical. That is three triangular sides may have non-equal sides to form an asymmetrical triangular pyramid or a non-regular tetrahedron. This makes a line through the apex have an angle of cantation with a normal line perpendicular to a plane parallel with the base surface.

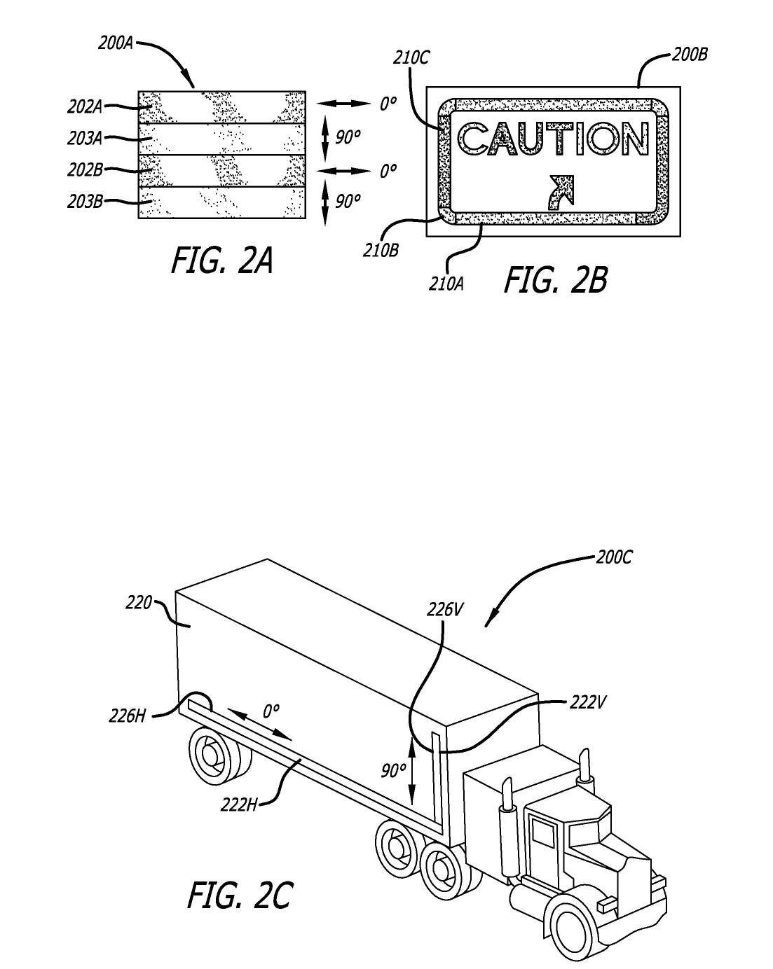

Referring now to FIG. 2A, retro-reflective sheeting with corner cubes having a single orientation often have limited performance when rotated ninety degrees. To gain more uniformity, a plurality of alternating strips 202A,203A,202B,203B with alternating orientations of corner cubes (e.g., 0 and 90 degrees) have been used to provide a retro-reflector 200A with an overall improved angular and reflective performance from that of a single orientation. However, using two different strips is not convenient and has linear edges.

Referring now to FIG. 2B, a caution sign 200B has retro-reflective strip portions 210A-201C cut from the same retro-reflective sheet, for example, having a single orientation. For a given angle of incidence of light, the caution sign may reflect non-uniformly. For example, the vertical strip portion 210C may reflect more brightly than the horizontal strip portion 210A for a given angle of incidence of light. The non-uniformity may make the caution sign appear unreadable at night. It would be preferred if the strip portions could be cut from the same retro-reflective sheet and reflect more uniformly regardless of their orientation in a sign.

FIG. 2C illustrates a container 220 of a tractor trailer 200C with retro-reflector strip portions 222H and 222V cut from a single orientation retro reflective sheet. The vertical strip portion 222V is affixed to the truckable container 220 with its corner cubes oriented at ninety degrees to that of the corner cubes of the horizontal strip portion 222H. As a result, at certain angles of incident of light, one of strip portions 222V or 222H may be more visible than the other. Accordingly, the size of the container 220 may not be fully appreciated at night when light of a given incident angle is shinning upon it. It would be preferred to provide a more uniform reflectivity of light for each strip portion so that the size of the container can be better ascertained at night.

Based on demands of various industry specifications for visibility of retro-reflective materials and the desire to produce a product that can be applied in more than one orientation, freely combining areas of two or more corner cube orientations onto retro-reflective sheeting is desired. Construction of corner cubes that use total internal reflection to reflect incident light is desirable. In another embodiment of the invention, provision of a sealed air gap between the cube faces and backing film is further desirable.

Master Tool to form Patterned Sheeting

A master tool is used to form a surface pattern in patterned sheeting, such as retro-reflective sheeting, during its manufacture. As discussed further herein, the master tool is used to form replicas that are used in the manufacture of patterned sheeting. While a master tool is briefly described herein, additional details of embodiments of the master tool are described in U.S. Provisional Patent Application No. 61/311,088 entitled MASTER TOOLS AND PATTERNED SHEETING WITH PERIODIC ROTATED PATTERNED REGIONS filed on Mar. 5, 2010 by David Reed et al. previously incorporated herein by reference.

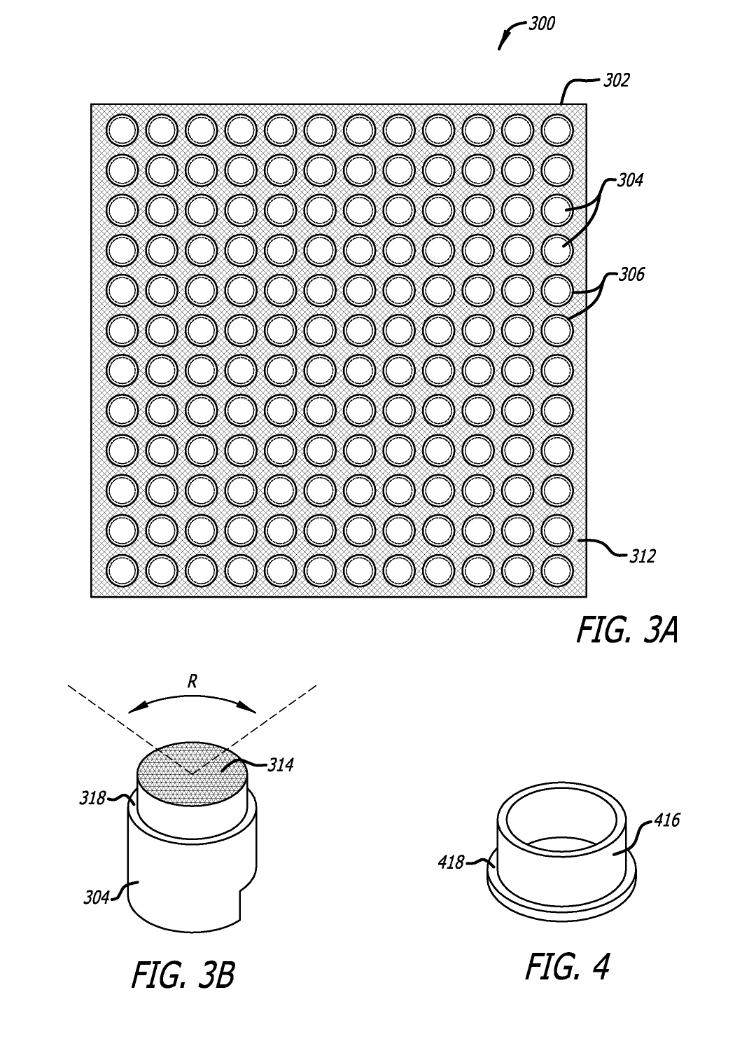

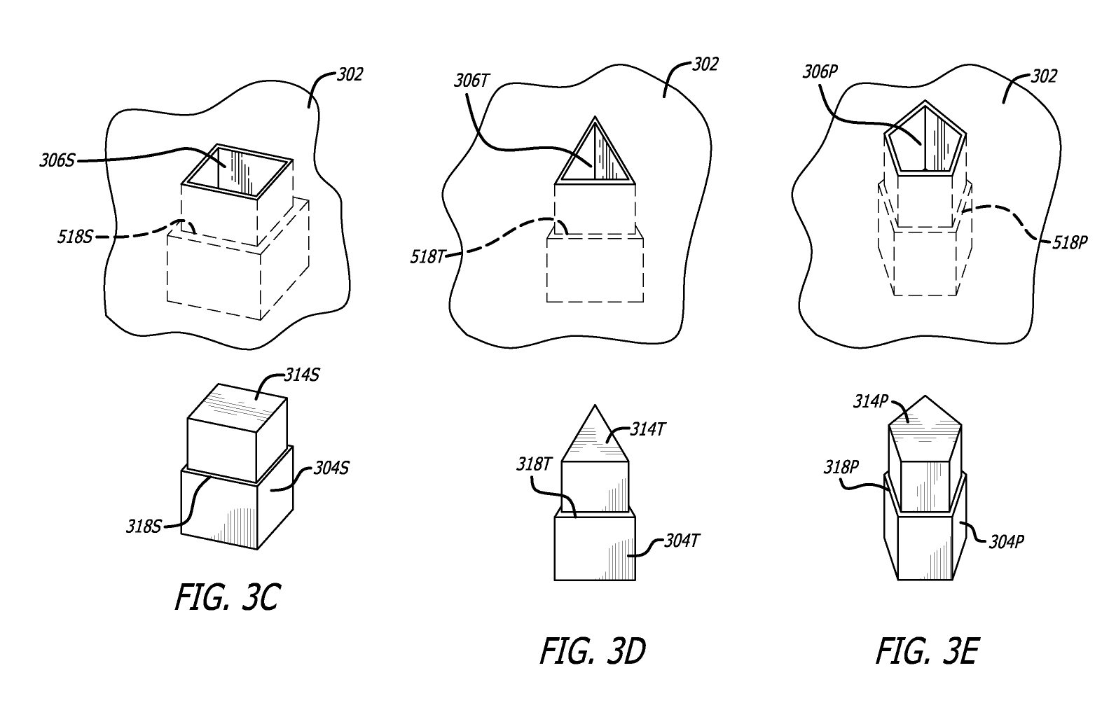

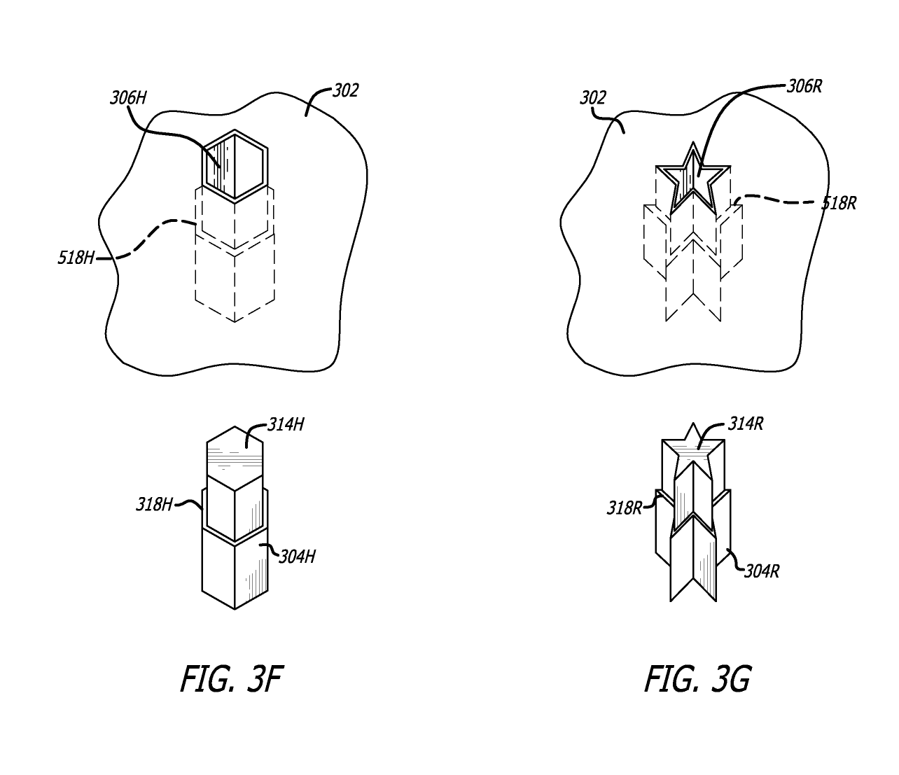

Referring now to FIGS. 3A-3B, the master tool 300 includes a slab or top plate 302 and a plurality of rotatable buttons 304. The top plate 302 has a top micromachined surface 312. The rotatable buttons 304 also have a top micromachined surface 314. The top micromachined surface of the top plate 302 is a single tile that may be replicated and tiled together across a surface of an optical material. The cross section shape of the top plate and the shape of the tile may be a regular polygon shape, a kite shape, or a rhombus shape so that it can be readily tiled together. For example the shape of the tile and the cross sectional shape of the top plate may be a square, an equilateral triangle, a regular pentagon, a regular hexagon, a regular octagon, a regular nonagon, or a regular decagon.

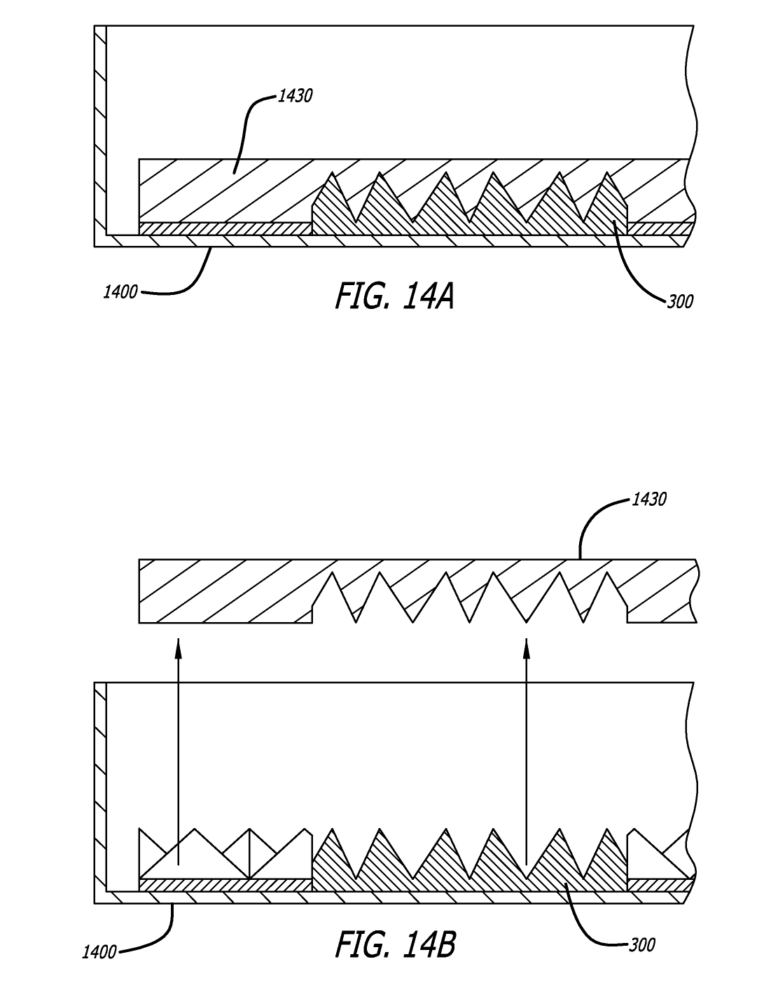

The master tool 300 is used to form a plurality of replicas (e.g., see replica 1430 formed out of the master tool 300 in FIGS. 14A-14B). The plurality of replicas are used as stampers, embossers, or molds during the manufacture of patterned sheeting, such as retro-reflective sheeting.

The top plate 302 has an array of holes 306. A plurality of rotatable buttons 304 fit within the array of holes 306 to form an array of a plurality of buttons in the tool. The cross-section of the buttons and the openings are a regular polygon.

The top surface 312 of the top plate 302 and top surface 314 of the rotatable buttons 304 are fabricated from a metallic material, such as brass or copper, which may be machined to an optical finish with a diamond cutting tool. The surface 312 of the top plate 302 and the top surfaces 314 of the rotatable buttons 304 may be arranged to be in the same plane for cutting and cut coincidentally as a single pattern. Alternatively, the surface 312 of the top plate 302 and the top surfaces 314 of the rotatable buttons 304 may be arranged to be in the different planes for cutting so that each may be cut separately with different patterns.

When forming replicas, one or more or all of the rotatable buttons 304 may be rotated by a rotational angle R within the holes 306 to orient them and the pattern in their surface 314 in a direction different from the pattern in the slab surface 312. A number of N resettable buttons 304 may each be rotated by different angles R₁-R_{N} within the holes 306 of the master tool 300 to form a replica and patterned sheeting with desired variations in circular regions from a background pattern. For example, the N buttons that are rotated may be in alternating rows or columns.

Circular rotatable buttons in circular holes provide for a wide range of angles R₁-R_{N} over which they may be rotated. If fewer angles can be supported, the rotatable buttons and the holes in which they are inserted may take on different geometric shapes other than a circle such as a regular polygon that is equiangular (all angles are equal in measure) and equilateral (all sides have the same length) including regular convex polygons and regular star polygons so that the button may be rotated, turned, or re-positioned in a similar shaped hole.

Referring now to FIGS. 3C-3G, rotatable buttons with different cylindrical shapes are shown that may be fitted into holes of the same cylindrical shape. Each rotatable button has a larger base cylindrical shape than a top cylindrical shape with the top surface pattern in order to form a shoulder. Similarly, each hole has a larger hollow base cylindrical shape than that of the hollow top cylindrical shape to form a shoulder rest or stop. Furthermore, each rotatable button and matching hole has a cross section that is a regular polygon with equal length sides (equilateral) and equal angles at each vertex (equiangular).

FIG. 3C illustrates a square rotatable button 304S with a square orientable patterned surface 314S and a square cylindrical body. Square rotatable buttons 304S fit into square holes 306S and can be re-oriented by ninety (90) degree increments of 90, 180, and 270 degrees. The square rotatable button 304S has a square shaped shoulder 318S that may come to rest against a square shaped rest or stop 518S in the square cylindrical shaped hole 306S.

FIG. 3D illustrates a triangular rotatable button 304T with a triangle orientable patterned surface 314T and a triangle cylindrical body. Triangular rotatable buttons 304T fit into triangle cylindrical holes 306T and can be re-oriented by one-hundred-twenty (120) degree increments of 120 and 240 degrees. The triangular rotatable button 304T has a triangular shaped shoulder 318T that may come to rest against a triangular shaped rest or stop 518T in the triangle cylindrical shaped hole 306T.

FIG. 3E illustrates a pentagonal rotatable button 304P with a pentagon orientable patterned surface 314P and a pentagon cylindrical body. Pentagonal rotatable buttons 304P fit into pentagonal cylindrical holes 306P and can be re-oriented by seventy-two (72) degree increments of 72, 144, 216, and 288 degrees. The pentagonal rotatable button 304P has a pentagonal shaped shoulder 318P that may come to rest against a pentagonal shaped rest or stop 518P in the pentagon cylindrical shaped hole 306P.

FIG. 3F illustrates a hexagonal rotatable button 304H with a hexagon orientable patterned surface 314H and a hexagon cylindrical body. Hexagonal rotatable buttons 304H fit into hexagonal cylindrical holes 306H and can be re-oriented by sixty (60) degree increments of 60, 120, 180, 240, and 300 degrees. The hexagonal rotatable button 304H has a hexagonal shaped shoulder 318H that may come to rest against a hexagonal shaped rest or stop 518H in the hexagon cylindrical shaped hole 306H.

FIG. 3G illustrates a star rotatable button 304R with a star orientable patterned surface 314R and a star cylindrical body. Star rotatable buttons 304R fit into star cylindrical holes 306R. If five sided as shown, a star rotatable button can be re-oriented by seventy-two (72) degree increments of 72, 144, 216, and 288 degrees. If the triangle shape is N-sided, a star rotatable button can be re-oriented by increments of N/360 degrees. The star rotatable button 304R has a star shaped shoulder 318R that may come to rest against a star shaped rest or stop 518R in the star cylindrical shaped hole 306R.

Generally, a rotatable button may be shaped to any other geometric cylindrical shape having equilateral sides to fit in openings having the same geometric cylindrical shape but hollow with equilateral sides.

The pattern that may be cut into the top surfaces (background patterned surface 312 and each orientable patterned surface 314) of the of the master tool 300 may be a pattern of retro-reflectors, such as a full corner cube pattern. To form a pattern of retro-reflectors in a surface of sheeting, three V shaped grooves are machined in three different directions to form corner cubes with three faces oriented approximately orthogonal to each other. The optical axis (or symmetry axis between the corner cube faces) of a corner cube may be canted or tilted away from an orthogonal axis with a top plane surface of the master tool in order to achieve wider angularity in any defined viewing plane of retro-reflective sheeting. U.S. Provisional Patent Application No. 61/311,088 entitled MASTER TOOLS AND PATTERNED SHEETING WITH PERIODIC ROTATED PATTERNED REGIONS filed on Mar. 5, 2010 by David Reed et al., previously incorporated herein by reference, further describes cutting patterns, including V shaped grooves, into the top surfaces of master tooling.

Additional V-shaped grooves, different shaped grooves, different cut angles, different orientation angles, different cutting depths, pattern tiling, and other known patterning techniques to obtain different types of corner cube pattern designs may be used and cut into the surfaces of the top plate and buttons that can be transferred into retro-reflective sheeting. Further information regarding different exemplary designs of corner cube patterns for the top patterned surfaces of the master tool are described in U.S. Pat. No. 3,057,256 (Erban—Oct. 6, 1962); U.S. Pat. No. 3,712,706 (Stamm—Jan. 23, 1973); U.S. Pat. No. 4,189,209 (Heasley—Feb. 19, 1980); U.S. Pat. No. 4,202,600 (Burke—May 13, 1980); U.S. Pat. No. 4,243,618 (Van Arnam—Jan. 6, 1981); U.S. Pat. No. 4,588,258 (Hoopman May 13, 1986); U.S. Pat. No. 4,938,563 (Nelson—Jul. 3, 1990); U.S. Pat. No. 5,564,870 (Benson—Oct. 15, 1996); U.S. Pat. No. 5,565,151 (Nilsen—Oct. 15, 1996); U.S. Pat. No. 5,706,132 (Nestegard—Jan. 6, 1998); U.S. Pat. No. 5,764,413 (Smith—Jun. 9, 1998); U.S. Pat. No. 5,831,767 (Benson—Nov. 3, 1998); U.S. Pat. No. 5,898,523 (Smith—Apr. 27, 1999); U.S. Pat. No. 5,936,770 (Nestegard—Aug. 10, 1999); U.S. Pat. No. 6,168,275 (Benson—Jan. 2, 2001); U.S. Pat. No. 6,258,443 (Nilsen—Jul. 10, 2001); U.S. Pat. No. 6,457,835 (Nilsen—Oct. 1, 2002); U.S. Pat. No. 6,533,887 (Smith—Mar. 18, 2003); and U.S. patent application Ser. No. 08/139,462 (Benson—Oct. 20, 1994) published as International Publication No. WO 95/11465 on Apr. 27, 1995; all of which are hereby incorporated by reference.

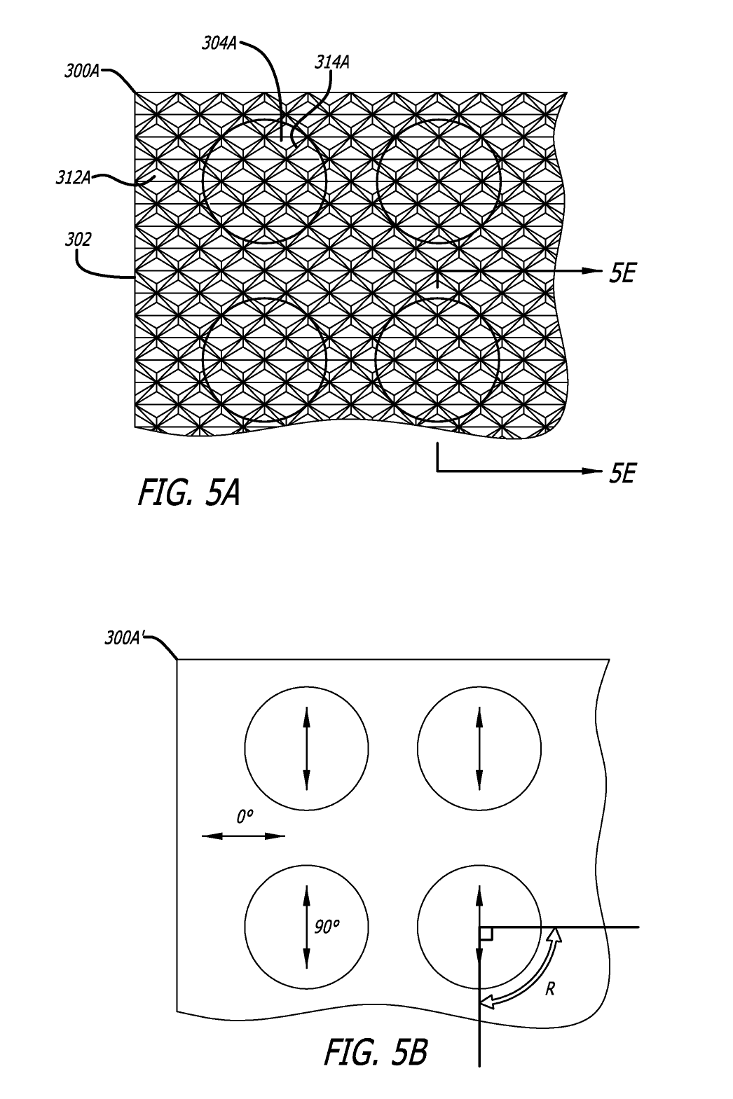

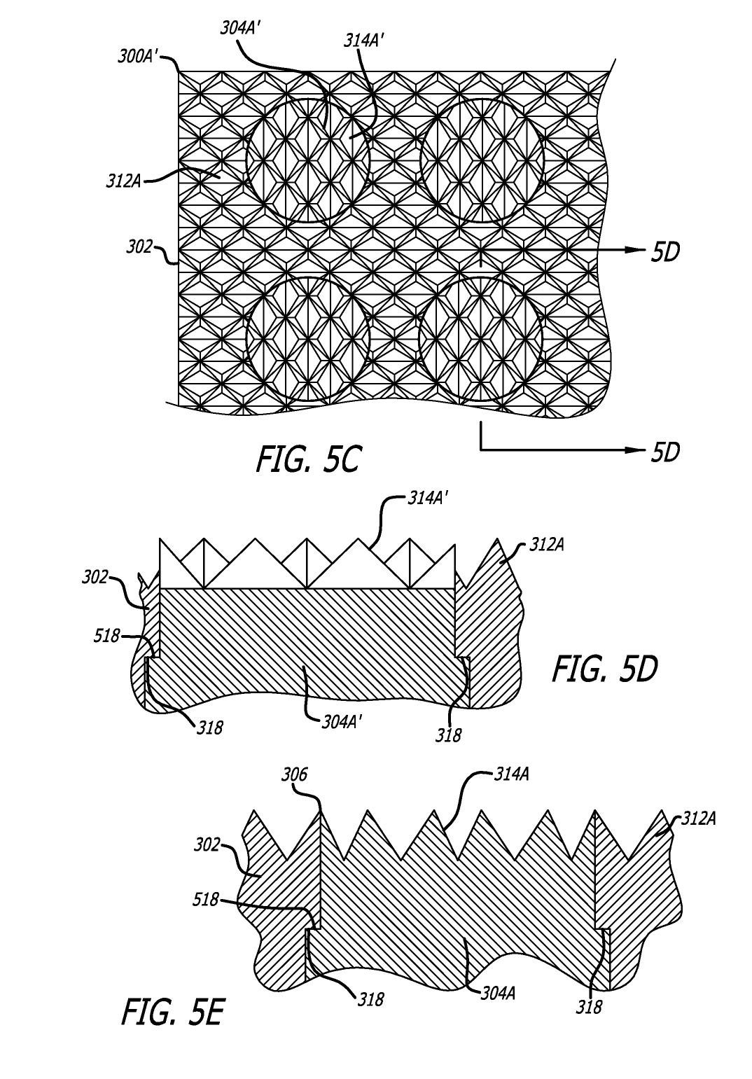

Referring now to FIGS. 5A, a corner of the master tool 300A is shown with the top surface 314 of the rotatable buttons 304A arranged to be in the same plane with the surface 312 of the top plate 302 such that the three V-shaped grooves can be concurrently cut as a single corner cube pattern across all top surfaces of the master tool in one embodiment of the invention. As a result, a background pattern of corner cubes 312A is formed in the top background patterned surface 312 and a circular region of corner cubes 314A is formed in the top orientable surface 314 of each rotatable button 304A as shown in FIG. 5E. FIG. 5E further illustrates the shoulder 318 of the rotatable button 304A resting against a shoulder rest 518 of the hole or opening 306.

After a uniform corner cube pattern is cut across all top surfaces of the master tool in the one embodiment of the invention, the rotatable buttons 304A may each then be rotated to orient some or all in a different orientation from the top background surface patterned surface 312A. The rotatable buttons 304A may rotated by an angle R, such as ninety degrees, to provide an overall pattern design to manufacture a retro-reflective sheeting with wide angularity in multiple viewing planes.

FIG. 5B is a schematic view of a corner of the master tool 300A′ with rotatable buttons rotated from their initial cut position by an angle R. In one embodiment of the invention, the angle R of re-orientation of the rotatable buttons is ninety (90) degrees. However, it is to be understood that other angles R of rotation of the rotatable buttons may be made.

Referring now to FIGS. 5C and 5D, the rotatable buttons 304A′ in the master tool 300A′ have been rotated by ninety degrees, for example, from that of their initial orientation shown by the buttons 304A in FIG. 5B and 5E. The circular regions of corner cubes 314A′ in the top surface 314 of each rotatable button 304A′ are now oriented in a different direction (e.g., perpendicular or orthogonal) in comparison with the background pattern of corner cubes 312A in the surface 312 of the top plate 302 and the circular region of corner cubes 314A in the initial orientation of the rotatable buttons 304.

If the master tool 300A is used to form retro-reflective sheeting, a first angularity and a first retro-reflective performance is provided for incident light. If instead the master tool 300A′ is used to form retro-reflective sheeting, not only is a first angularity with a first retro-reflective performance provided, but a second angularity with a second retro-reflective performance is provided for incident light differing from the first angularity and first retro-reflective performance provided by the master tool 300A. That is, by rotating the rotatable buttons 304A with the circular corner cube regions 314A within the master tool, a different retro-reflective sheeting with different retro-reflective performance can be manufactured.

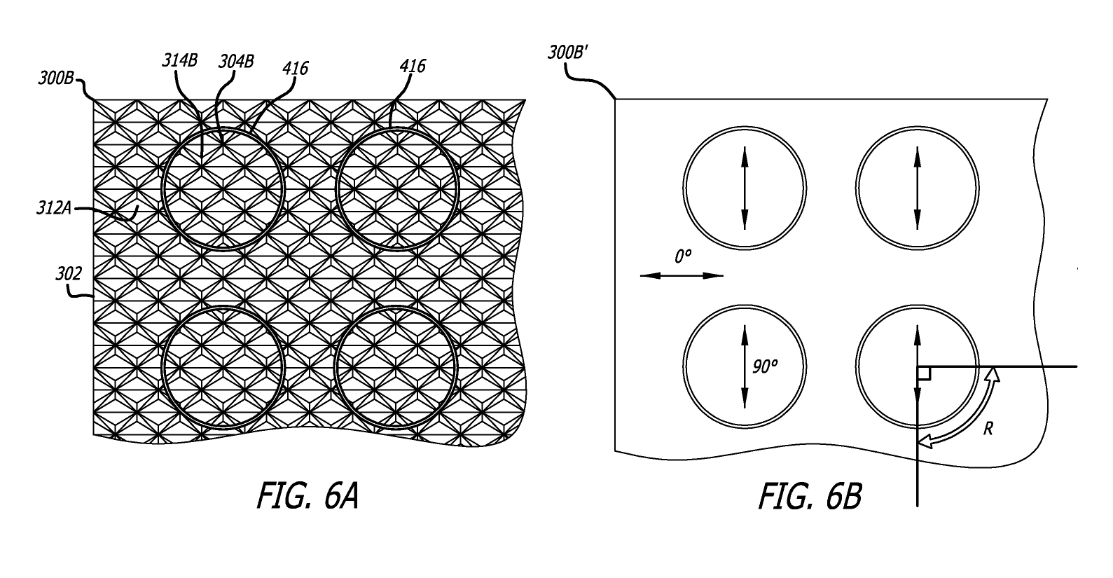

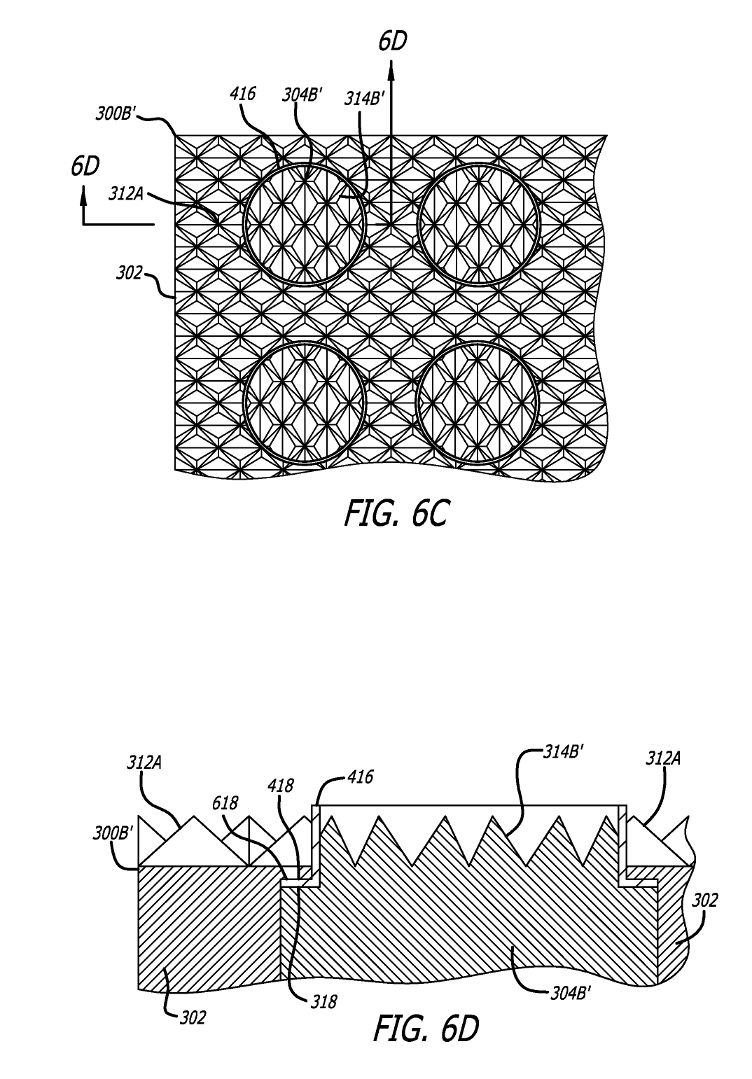

Referring now momentarily to FIG. 4, a sleeve 416 is illustrated that may be positioned around each rotatable button 304B (see also FIGS. 6A, 6C, 6D). Each sleeve and rotatable button subassembly may be inserted together into the holes 113 of the top plate 102 of the master tool. As shown in FIG. 6D, the sleeve 416 has a height that extends above a plane of the peaks of corner cubes in the background pattern surface 312A and the orientable pattern surface 314A of corner cubes in the top surface 314 of each rotatable button 304A. The sleeve 416 may have a shoulder 418 that buts up against the shoulder 318 in the rotatable button 304B on one side. An opposite side of the shoulder 418 may come to butt or rest upon a shoulder rest or stop 618 in the top plate 302.

The rotatable buttons 304B have a smaller diameter than the diameter of the holes 306 in the top plate 302. The sleeve 416 fills in the gap between the rotatable buttons 304B and the holes 306 for machining of the orientable patterned surface and the background patterned surface. After machining of the patterns, such as a pattern of corner cubes, the sleeves 416 may be positioned so that they are slightly protruding above the pattern, such as the plane of the tips or peaks of the corner cube pattern.

The portion of the sleeve 416 extending through the hole 306 may be used to form a seal pattern in retro-reflective sheeting. When stamper or molds are made, the replicas of the protruding sleeves will provide a raised seal surface for attachment of a backing film that does not substantially contact or deform adjacent cube corners, said arrangement providing an air gap adjacent to the cube corners.

FIG. 6A illustrates a top view a corner of a master tool 300B that includes the sleeves 416 around each rotatable button 304B. In FIG. 6A, the rotatable buttons 304B are in the same orientation as when they were cut as the orientation of the corner cubes in the background patterned surface 312A is the same as the corner cubes in the orientable patterned surface 314B on top of each rotatable button.

After a uniform corner cube pattern is cut across all top surfaces of the master tool, the rotatable buttons 304B may each then be rotated to orient some or all in a different orientation from the top background surface patterned surface 312A. The rotatable buttons 304B may rotated by an angle R, such as ninety degrees, to provide an overall pattern design to manufacture a retro-reflective sheeting with wide angularity in multiple viewing planes.

FIG. 6B is a schematic view of a corner of the master tool 300B′ with rotatable buttons rotated from their initial cut position by an angle R. In one embodiment of the invention, the angle R of re-orientation of the rotatable buttons is ninety (90) degrees. However, it is to be understood that other angles R of rotation of the rotatable buttons may be made.

Referring now to FIGS. 6C and 6D, the rotatable buttons 304B′ in the master tool 300B′ have been rotated by ninety degrees, for example, from that of their initial orientation shown by the buttons 304B in FIG. 6A. The circular regions of corner cubes 314B′ in the top surface 314 of each rotatable button 304B′ are now oriented in a different direction (e.g., perpendicular or orthogonal) in comparison with the background pattern of corner cubes 312A in the surface 312 of the top plate 302 and the circular region of corner cubes 314B in the initial orientation of the rotatable buttons 304B.

If the master tool 300B is used to form retro-reflective sheeting, a first angularity and a first retro-reflective performance is provided for incident light. If instead the master tool 300B′ is used to form retro-reflective sheeting, not only is a first angularity with a first retro-reflective performance provided, but a second angularity with a second retro-reflective performance is provided for incident light differing from the first angularity and first retro-reflective performance provided by the master tool 300B. That is, by rotating the rotatable buttons 304B with the circular corner cube regions 314B within the master tool, a different retro-reflective sheeting with different overall retro-reflective performance can be manufactured. The rotatable buttons allow the overall retro-reflective performance of a design for retro-reflective sheeting to be selectively changed with a mere change in position of the rotatable buttons. Moreover, if either the top surface pattern of the master tool 300B or 300B′ is used to manufacture retro-reflective sheeting, the sleeve 416 forms an integral raised seal pattern into the design of the retro-reflective sheeting. The raised seal pattern allows attachment of a backing sheet and adhesive while maintaining an air gap and protecting a pattern of total internal reflecting cube corners from damage, moisture, etc that might otherwise reduce reflective performance or optical efficiency.

Alternatively, a raised ring or raised perimeter wall structure may be formed in the background patterned surface 312A around each hole 306 of the array of holes. Alternatively, a raised ring or raised perimeter wall structure may be formed in the orientable patterned surface around a perimeter of each rotatable button 304B. In either case, the raised ring or raised perimeter wall structure has a height greater than a plane formed by peaks of the corner cubes.

While the background pattern of corner cubes formed in the top surface of the top plate and the circular region of corner cubes formed in the top surface of each rotatable button may be cut at the same time to initially have a substantially uniform pattern, the top surfaces of the rotatable buttons may be cut separately from the top surface of the top plate. The rotatable buttons may be removed or lowered beneath the top surface of the plate. The background surface may be formed of a first pattern of corner cubes cut into the top surface of the top plate. The top surfaces of the rotatable buttons may then be raised above a top plane of the background surface of the top plate to allow cutting of a second pattern different from the first pattern in the top surface of each rotatable button. The second pattern forming the orientable patterned surface in each rotatable button may be a second pattern of corner cubes with a totally different orientation that the first or a second pattern of corner cubes with a different canting direction or different angle of cantation than the first.

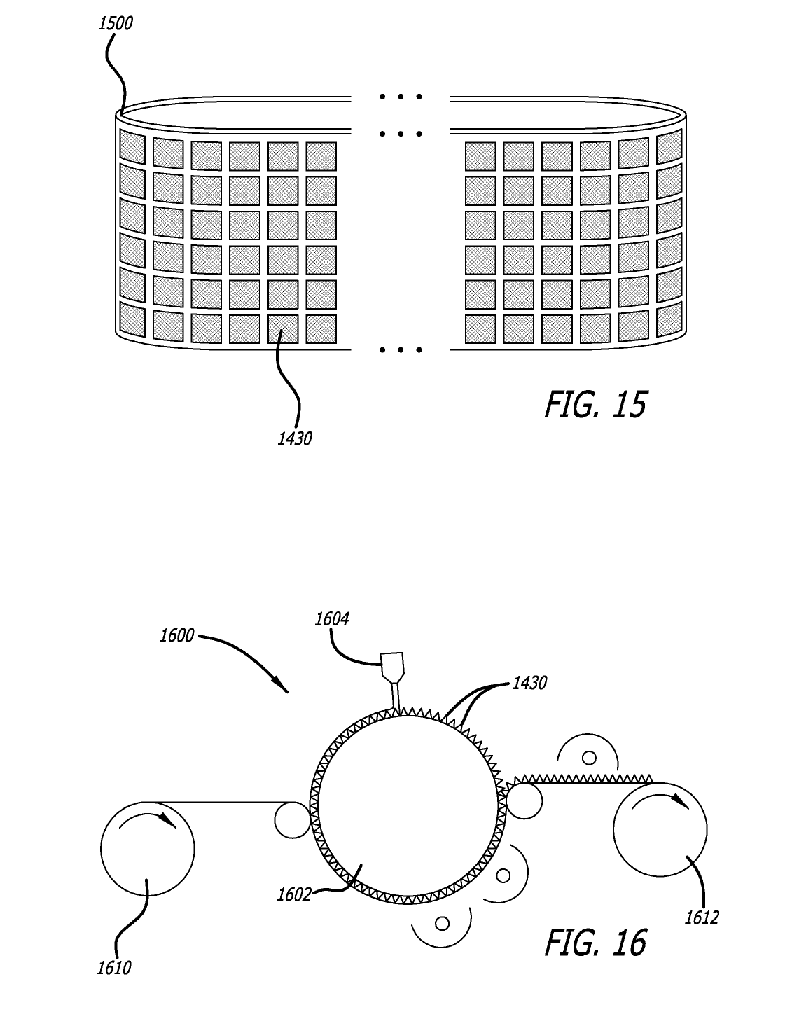

To manufacture retro-reflective sheeting, replicants of the master tool may formed and tiled in different orientations. FIG. 15 illustrates replicants 1430 of a master tool tiled together on a belt 1500 to manufacture retro-reflective sheeting. Alternatively, the shape and relative size of the master tooling may differ to manufacture different designs of retro-reflective sheeting. For example, the shape of the master tool, including the top plate and back plate, may have a diamond shape, a rectangular shape, a hexagonal shape, or other geometric shape that can be tiled. Furthermore, the array of rotatable buttons may vary in size from the 12 by 12, such as 5 by 20 or 60 by 10, for example. The shape and size of the rotatable buttons may also vary. Thus, the embodiments of the master tool provide substantial freedom to orient multiple sub-areas of corner cube patterns in any desired direction, and/or with any desired area fraction so as to form a desired incident light angularity corner cube pattern in retro-reflective sheeting.

Retro-Reflective Sheeting with Circular Corner Cube Regions

In response to the design of the master tool, an overall pattern is formed into a surface of the retro-reflective sheeting. The pattern of the top surface of a master tool is continuously formed into a surface of an optical film or layer to generate a continuous pattern in a patterned film, layer of sheet. The optical film or layer is a plastic material that may heated into a liquid state so that the pattern can be molded into one of its surfaces. The master tool with the rotatable buttons forms periodic corner cube regions in patterned sheeting with different orientations to provide a different overall pattern of retro-reflective performance in retro-reflective sheeting. In some embodiments of the invention, the border of the periodic corner cube regions are defined by circular apertures rather than linear lines or edges to provide an overall retro-reflector pattern that is more agreeable to human eyes. A layer with printed letters, numbers, and/or symbols may be laminated to the optical film such that portions of the printed letters, numbers, and/or symbols overlap portions of a circle shaped border or boundary. With the circle shaped border or boundary, the printed letters, numbers, and/or symbols are more legible to human eyes when incident light is retro-reflected back.

In some embodiments of the invention, a periodic raised ridge seal pattern is integrally formed in the patterned sheeting. The raised ridge seal pattern may also have a circular ring shape and be formed around circular regions of corner cubes having the different orientation from the background corner cubes. The integral seal pattern may avoid adding cosmetic defects and optical losses that may be associated with a separately applied sealing pattern.

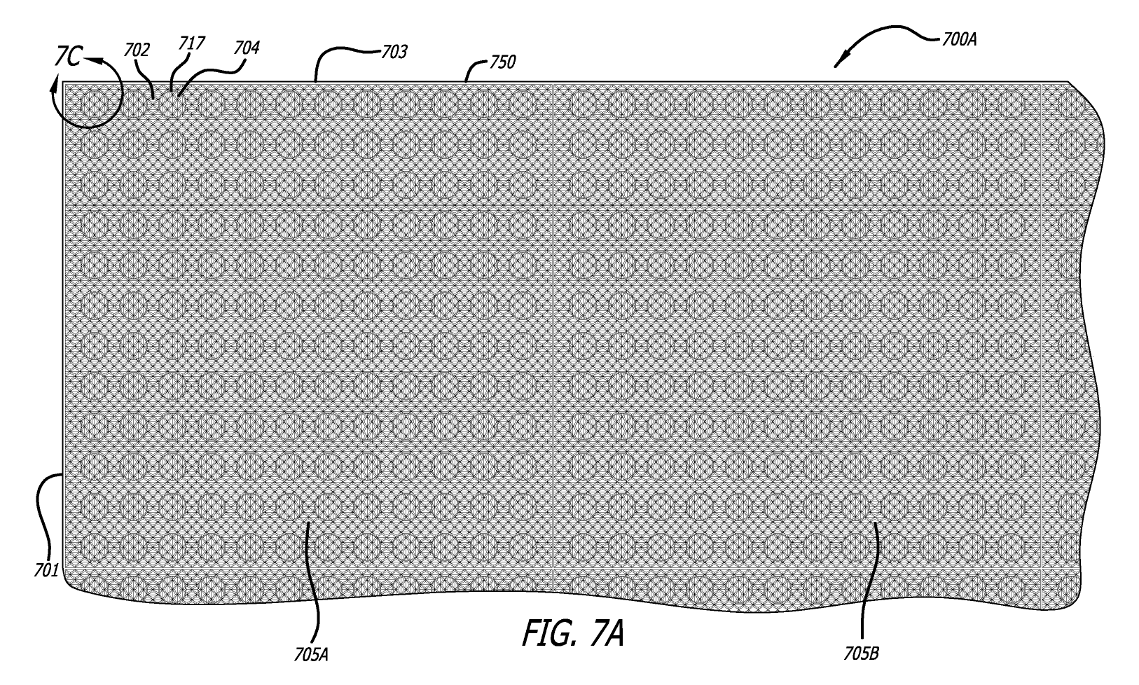

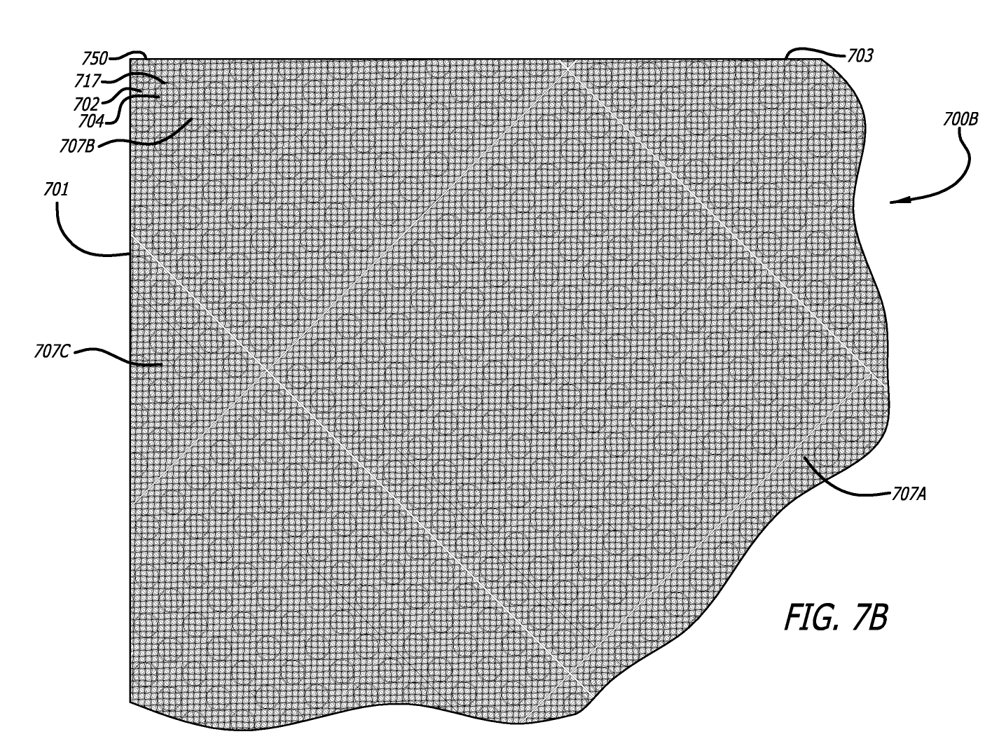

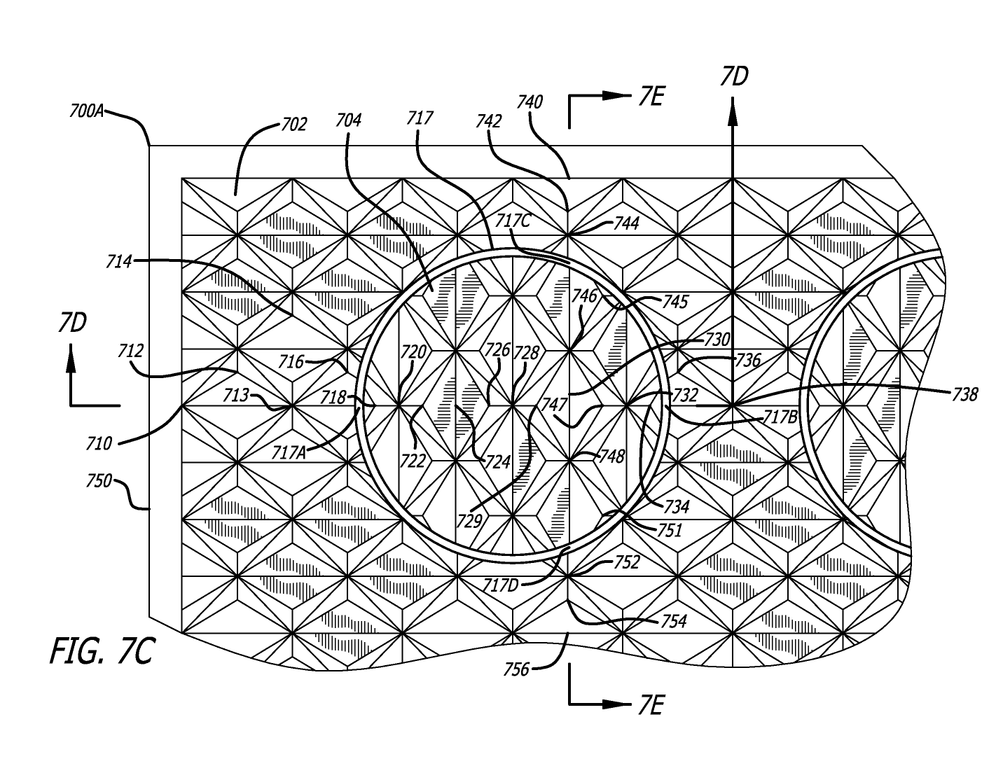

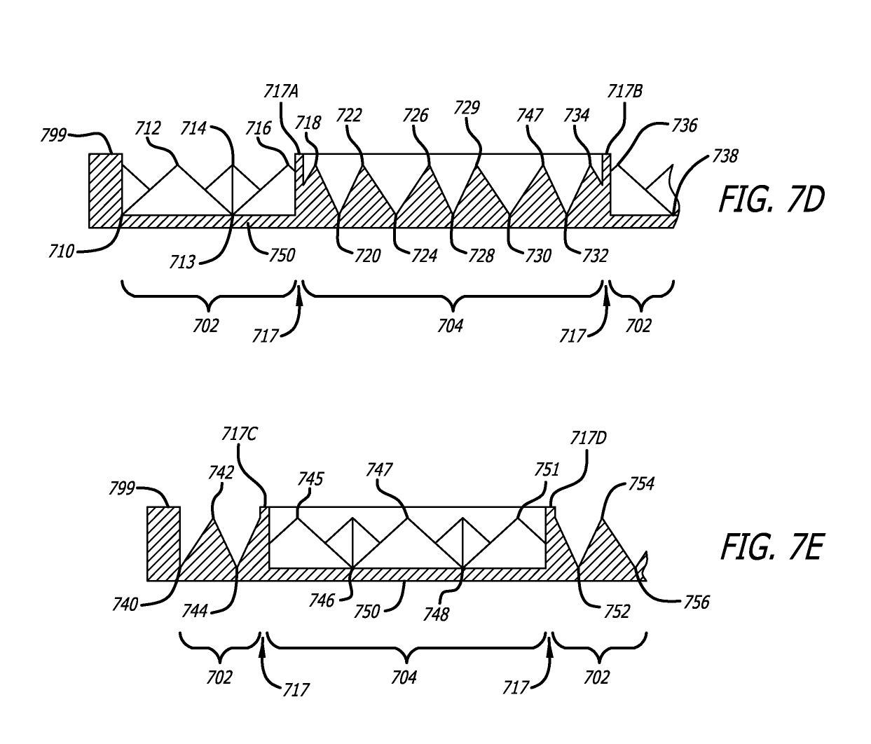

Referring now to FIG. 7A, a top view of a portion of a retro-reflective sheeting 700A is illustrated. The master tool 300B′ with sleeves 416 was used to make replicants and pattern a top geometric optical surface in the flexible optical material substrate 750 (may also be referred to as a film due to its thinness) to form the retro-reflective sheeting 700A. The replicants were tiled together with edges in parallel to edges of the sheeting 701, 703, such as shown by a first tiled master tool pattern 705A and a second tiled master tool pattern 705B in the top geometric optical surface of the sheeting 700A. A surround or background patterned region 702 and a plurality of periodic oriented patterned regions 704, each surrounded by a sealing ring 717, are formed in the top side surface of the sheeting 700A The plurality of periodic oriented patterned regions are spaced apart over the geometric optical surface. Each of the periodic oriented patterned regions 704 includes an array of corner cubes within a geometric shaped boundary having an orientation with respect to an edge of the retro-reflective sheeting. The background patterned region of corner cubes 702 surrounds each of the periodic oriented patterned regions 704 and has an orientation with the edge of the sheeting. The background patterned region differs from the plurality of periodic oriented patterned regions in retro-reflective performance by having a different orientation with respect to the edge of the sheeting or film, a different corner cube design with respect to the corner cube pattern, or both a different orientation and a different corner cube design. For example, different corner cube designs and shapes are shown in the US patents that were incorporated by reference. An angle difference in orientation between the background patterned region and the plurality of periodic oriented patterned regions may be selected from a range of angles (circular buttons) or a set of angles (buttons with a regular polygon shape) in accordance with the flexibility of the master tool.

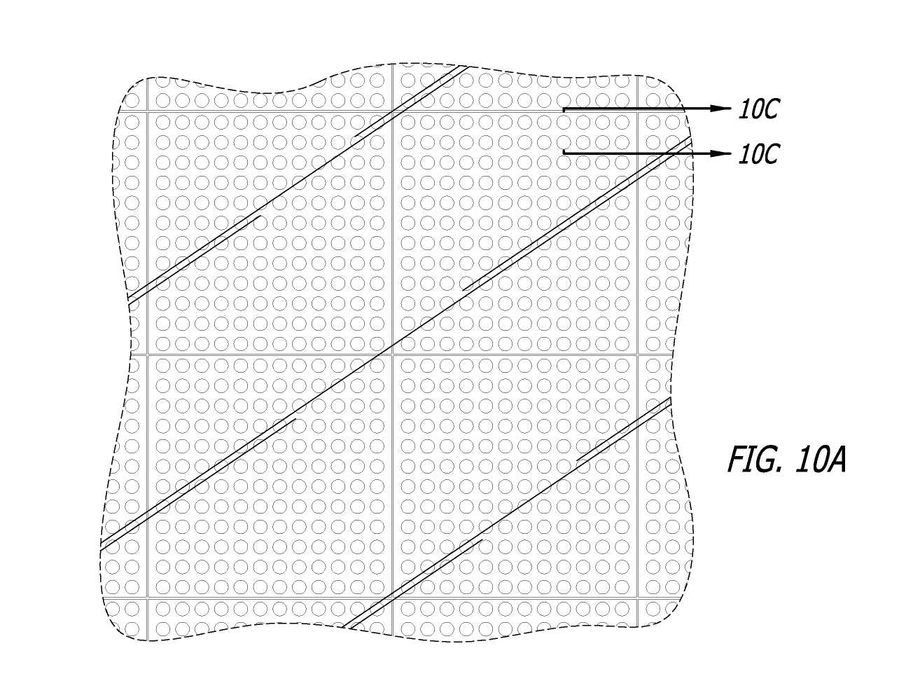

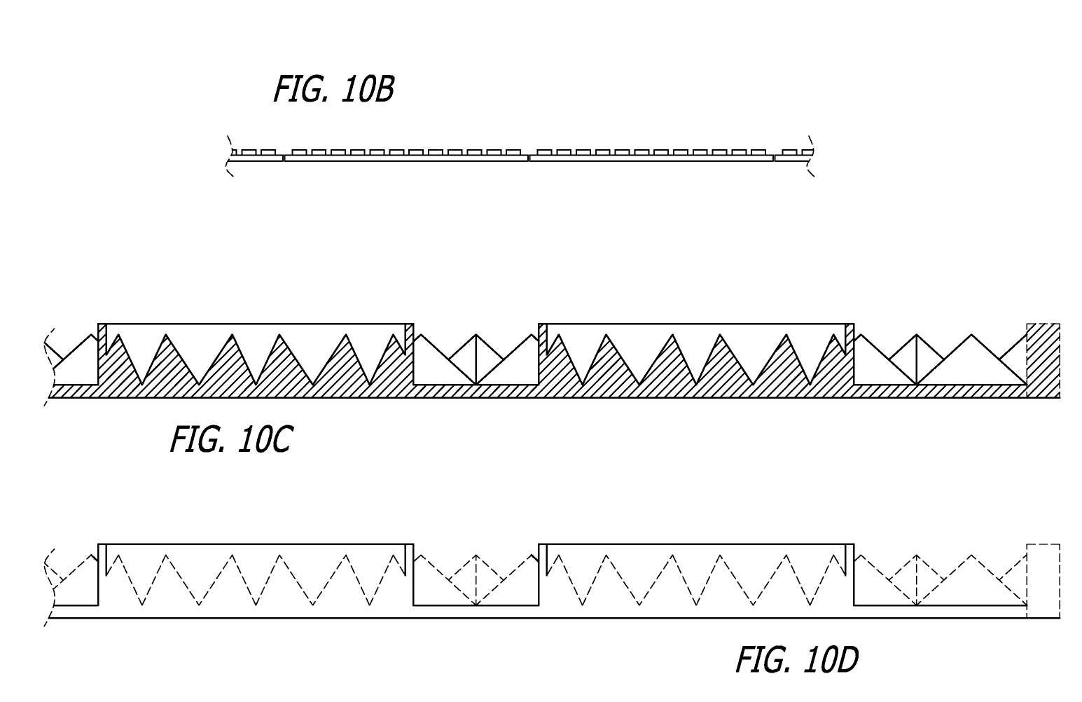

FIG. 10A illustrates a top view with less magnification and FIG. 10B illustrates a side view with less magnification of the pattern of a circular sealing ring that may be formed in the sheeting. The back surface of the sheeting, opposite the top geometric optical surface, has a smooth face to receive incident light rays into the sheeting and launch reflected light rays out of the sheeting.

Note that it is understood that the figures are not shown to scale so that the important aspects of the invention are not obscured. For example, the height of the corner cubes (typically 50 to 200 microns) is shown in the figures (e.g., FIGS. 7D-7E) to be greater than the thickness of the film or substrate (typically 200 to 500 microns for signage) when it may not be the case. This allows the orientation of the corner cubes to be better shown instead of the scaled height of the corner cubes or the thickness of the sheeting. Moreover, the size of the truncated corner cubes is exaggerated to more clearly show the different orientations, and thus, fewer corner cubes are shown across the diameter of the cross section. The number of corner cubes may typically be in the tens, hundreds or thousands of corner cubes across the diameter shown instead. Additionally, some of the figures of the retro-reflective sheeting are shown with one or more optional edge portions 799 that may or may not be formed therein depending upon the width of the substrate material and whether or not the edge of replicates are aligned with, cover over, or are short of the edge of the substrate material. If the edge portions 799 are present around the edge of the sheeting, they may be substantially the thickness of the substrate material. Furthermore if the edge portions 799 are present around the edges of the sheeting, they may be trimmed off in one or more subsequent process steps.

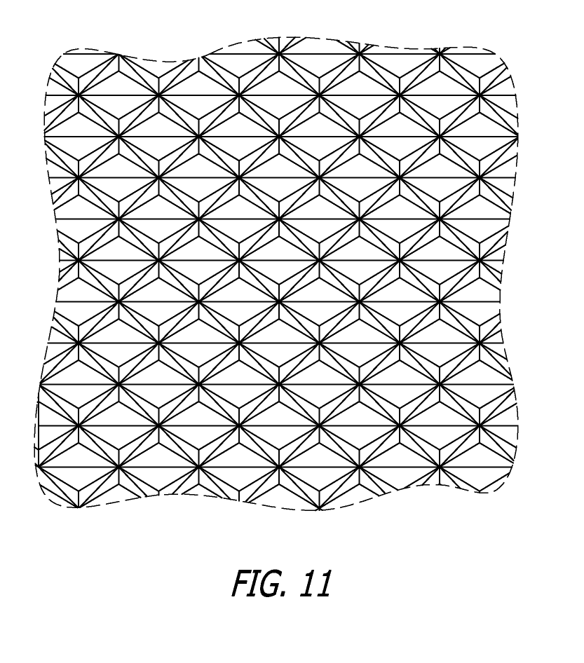

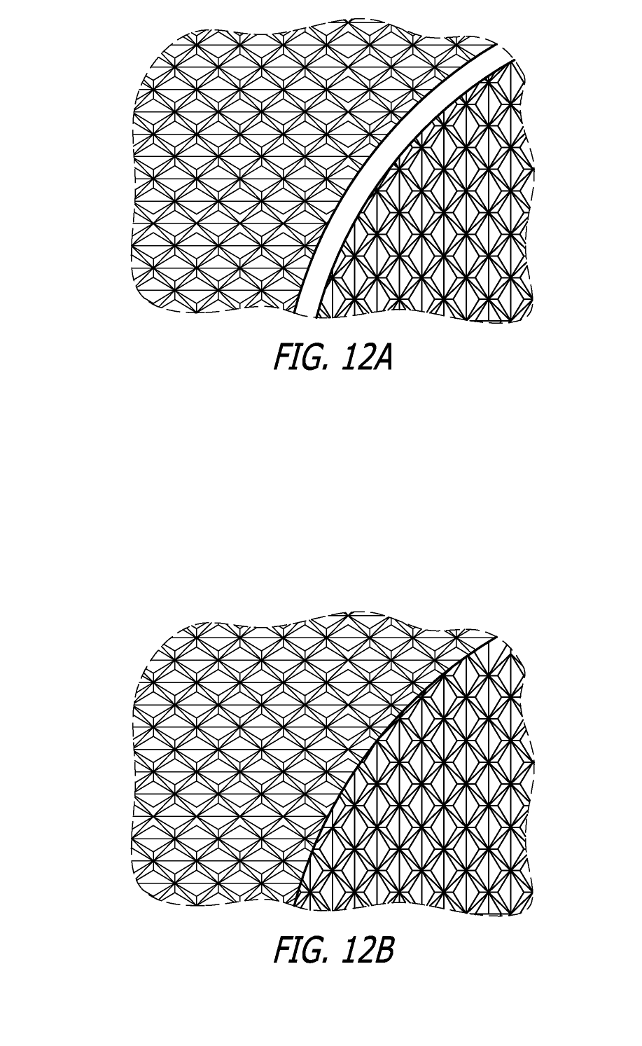

In one embodiment of the invention, the background patterned region 702A is a background corner cube patterned region with a first orientation and the periodic oriented patterned region 704A is a periodic circular corner cube region having a second orientation differing from the first orientation. FIG. 11 illustrates a magnified top view of the background corner cube patterned region with the first orientation. FIG. 12A illustrate a magnified top view of the sealing ring separating the background corner cube patterned region with the first orientation from the periodic circular corner cube region with the second orientation. FIGS. 10C and 10D illustrate cross-section views of the background patterned region 702 and the periodic oriented patterned region 704 surrounded by the sealing ring 717 (also referred to as a raised perimeter wall structure) formed in the sheeting 700A. The sealing ring 717 is integrally formed with the corner cubes to avoid extra steps in the manufacturing process and avoid damaging adjacent corner cubes from any extra step. When a backing layer is laminated to the sealing ring, an air pocket may be created over the corner cubes so that dirt, liquid, or other foreign object does not couple to a facet of the corner cubes and alter the optical properties thereof. The backing layer may have an adhesive film on the opposite side so that the retro-reflector may be readily attached to an object.

The background patterned region 702 in the sheeting provides a first retro-reflective performance over a first angularity range of incident light with respect to the sheeting. The periodic oriented patterned regions 704 differing in orientation in the sheeting provide a second retro-reflective performance over a second angularity range of incident light with respect to the sheeting differing from the first angularity range. The array of the plurality of corner cubes in the periodic oriented pattern regions (circular corner cube regions) 704 oriented differently reflect incident light differently than the background pattern region 702 of corner cubes. For example, at a given angle of incidence for the incident light into the sheeting, corner cubes in the periodic oriented pattern regions (circular corner cube regions) 704 when oriented differently from the background pattern region with reflect incident light a different efficiency than the corner cubes in the background pattern region, With different corner cube designs in the background pattern region 702 and the periodic oriented patterned regions 704, a shape of the plot of the second retro-reflective performance may also differ from a shape of the plot of the first retro-reflective performance. For example, a diamond pattern of corner cubes may be used in the periodic oriented patterned regions 704 while a prismatic patter of corner cubes may be used in the background pattern region 702. Alternatively, a tilt or cant angle may simply differ between corner cubes in the periodic oriented patterned regions 704 and the corner cubes of the background pattern region 702 to form a different shape of the plots for retro-reflective performance. By combining the retro-reflective performances together in the same sheeting, the overall performance of the sheeting 700A may improve and provide a wider range of incident angles with respect to the sheeting.

As discussed herein, the tiling of replicants may be performed differently to provide a different pattern and alter the overall retro-reflective performance or efficiency for a given angle of incidence of light. The shape of the master tool instead of having a square cross section may take on a different polygon cross-section, such as a regular polygon, a symmetric polygon, or a convex polygon cross section, to facilitate different ways of tiling replicants (tiles) together. The overall pattern of the tiling of replicants (tiles) together may be transferred across a width and along portions of a continued sheet of optical material sheeting or film.

Referring now to FIG. 7B, a top view of a portion of a retro-reflective sheeting 700B is illustrated. The master tool 300B′ with sleeves 416 was used to make replicants to form the retro-reflective sheeting 700B. The replicants were tiled with edges at angle to edges 701, 703 of the sheeting, such as shown by a first angled tiled master tool pattern 707A, a second angled tiled master tool pattern 707B, and a third angled tiled master tool pattern 707C in a surface of the sheeting 700B. The first angled tiled master tool pattern 707A is a full portion of a master tool pattern. The second angled tiled master tool pattern 707B and the third angled tiled master tool pattern 707C in the sheeting 700B are triangle corner portions of the master tool pattern. A background patterned region 702 and a periodic oriented patterned region 704 surrounded by the sealing ring 717 is formed in the sheeting 700B.

FIG. 7C illustrates a magnified top view of a corner of the retro-reflective sheeting 700A. FIG. 7C may also represent a portion of the pattern of the retro-reflective sheeting 700B. FIG. 7C illustrates a magnified view of the background patterned region 702 and the periodic circular patterned region 704 in the sheeting 700A. Further illustrated is the sealing ring 717 surrounding the periodic oriented patterned region 704. The magnified view of FIG. 7C also shows more clearly how corner cubes in the periodic circular patterned region 704 may be oriented differently from the orientation of corner cubes in the background pattered region 702 of a surface of retro-reflective sheeting. If the corner cubes in the background patterned region 702 have a first orientation of zero degrees, the corner cubes in the periodic oriented patterned region 704 may have a second orientation of substantially ninety degrees or over a range of angles about ninety degrees such as between eighty and one hundred degrees.

Referring now to FIGS. 7C and 7D, a number of peaks and troughs are indicated along portions of a primary groove in the background patterned region 702 and over portions of primary grooves in the periodic oriented patterned region 704. The sealing ring 717 separates the periodic oriented patterned regions 704 from the background patterned region 702.

The corner cubes meet at troughs 710, 713, 720, 724, 728, 730, 732, and 738 along an axis in the periodic oriented patterned region 704 and the background patterned region 702 as shown in FIG. 7D. With a different orientation of substantially ninety degrees, the corner cubes meet at peaks 718, 722, 726, 729, 747, and 734 within the periodic oriented patterned region 704 along the same axis, while corner cubes meet at peaks 712, 714, 716, 736 off of the axis within the background patterned region 702.

Referring now to FIGS. 7C and 7E, a number of peaks and troughs are indicated along a portion of a primary groove in the periodic oriented patterned region 704 and over portions of primary grooves in the background patterned region 702. The sealing ring 717 separates the periodic oriented patterned regions 704 from the background patterned region 702.

The corner cubes meet at troughs 740, 743, 746, 748, 752, and 756 along an axis in the periodic oriented patterned region 704 and the background patterned region 702 as shown in FIGS. 7C and 7E. With a different orientation of substantially ninety degrees, the corner cubes meet at peaks 742 and 754 within the background patterned region 702 along the same axis, while corner cubes meet at peaks 745, 747, and 751 off of the axis within the periodic oriented patterned region 704.

As shown in FIGS. 7D and 7E, a top surface of the sealing ring extends above the peaks of the corner cubes in the periodic oriented patterned regions 704 and the background patterned region 702. That is a plane on the top surface of the sealing ring is above a plane on top of the peaks of the corner cubes in the periodic oriented patterned regions 704 and a plane on top of the peaks of the corner cubes in the background patterned region 702.

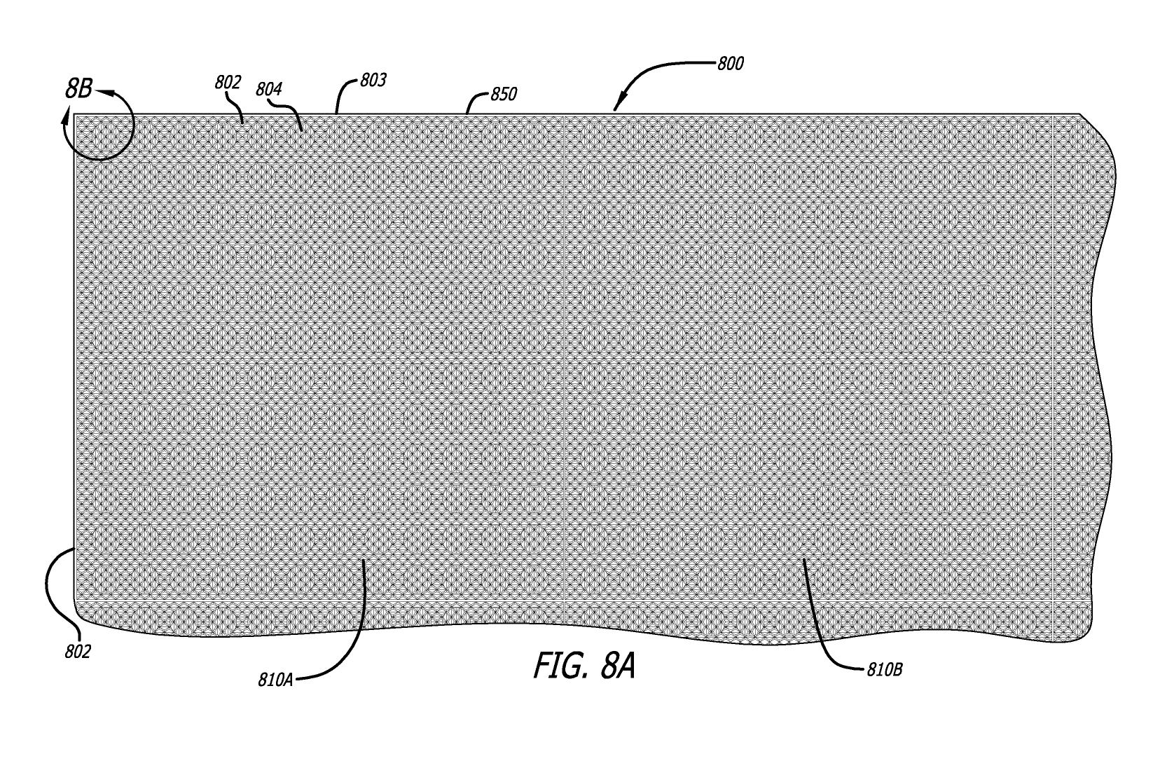

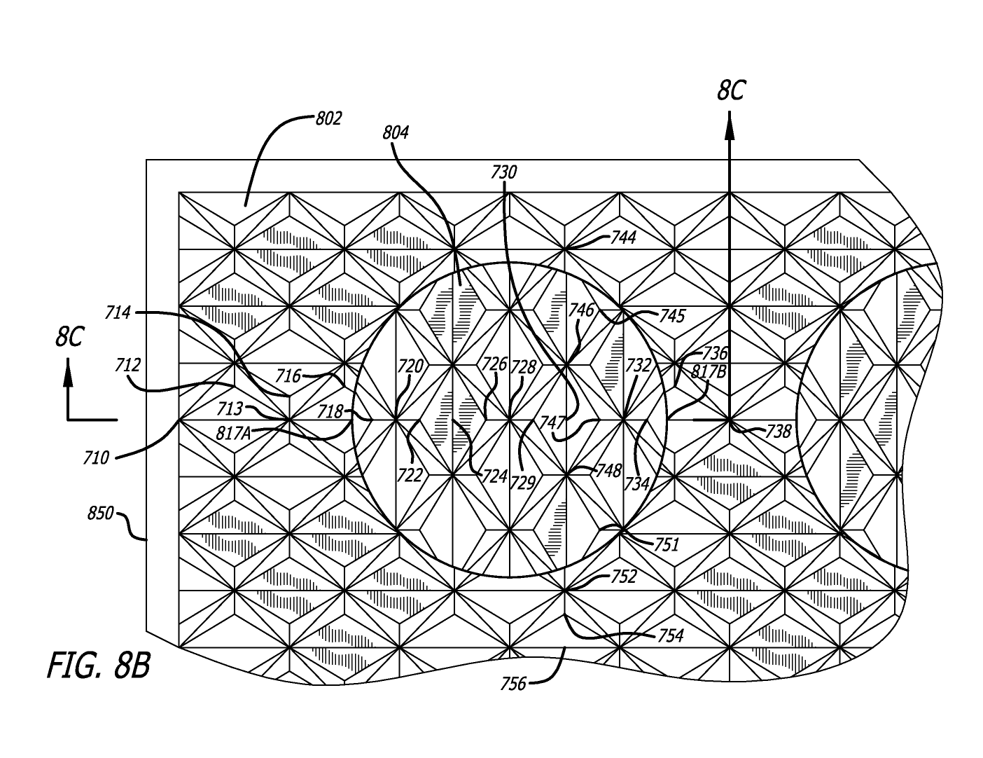

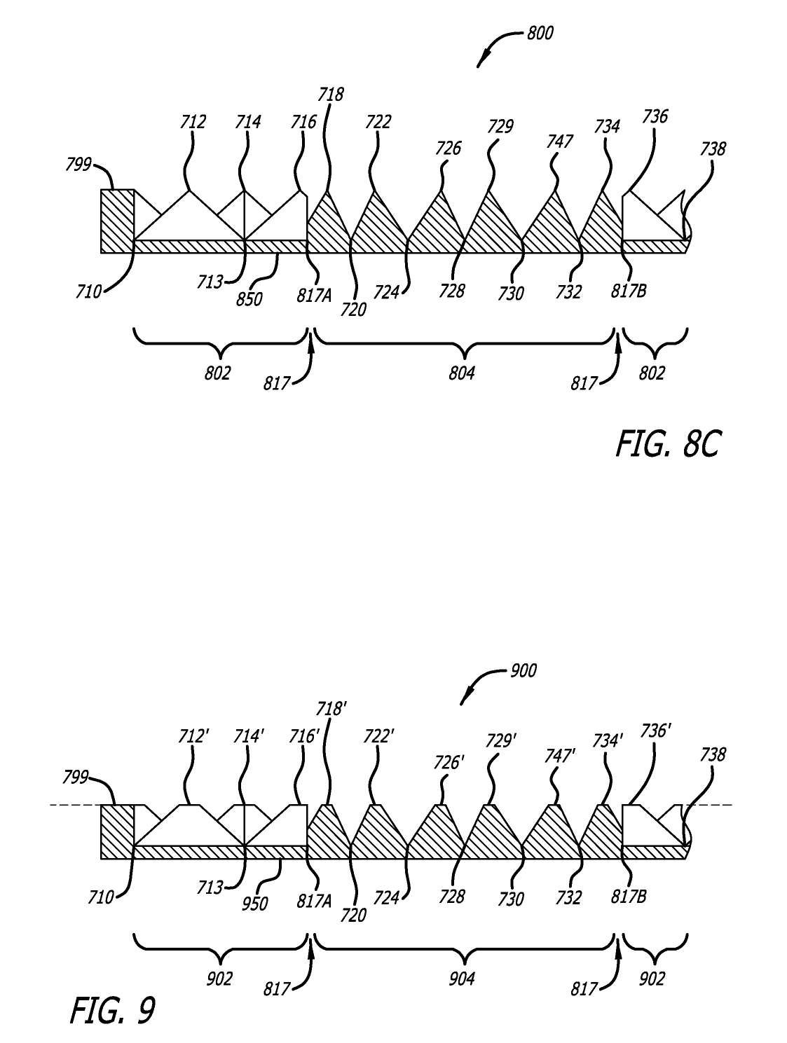

Referring now to FIG. 8A, a top view of a portion of a retro-reflective sheeting 800 is illustrated. The master tool 300A′ was used to make replicants and pattern a top geometric optical surface in the flexible optical material substrate 850 (may also be referred to as a film due to its thinness) to form the retro-reflective sheeting 800. The replicants were tiled with edges in parallel to edges of the sheeting 801, 803, such as shown by a first tiled master tool pattern 810A and a second tiled master tool pattern 810B in a surface of the sheeting 800. A surround or background patterned region 802 and a periodic oriented patterned region 804 is formed in the sheeting 800. The plurality of periodic oriented patterned regions are spaced apart over the geometric optical surface. Each of the periodic oriented patterned regions 804 includes an array of corner cubes within a geometric shaped boundary having an orientation with respect to an edge of the retro-reflective sheeting. The background patterned region of corner cubes 802 surrounds each of the periodic oriented patterned regions 804 and has an orientation with the edge of the sheeting. In one embodiment of the invention, the background patterned region 802 is a background corner cube patterned region with a first orientation and the periodic oriented patterned region 804 is a periodic circular corner cube region having a second orientation differing from the first orientation. The background patterned region differs from the plurality of periodic oriented patterned regions in retro-reflective performance by having the different orientation with respect to the edge of the sheeting or film, a different corner cube design with respect to the corner cube pattern, or both a different orientation and a different corner cube design. For example, different corner cube designs and shapes are shown in the US patents that were incorporated by reference. An angle difference in orientation between the background patterned region and the plurality of periodic oriented patterned regions may be selected from a range of angles (circular buttons) or a set of angles (buttons with a regular polygon shape) in accordance with the flexibility of the master tool.

Referring now to FIG. 8B a magnified top view of a corner of the retro-reflective sheeting 800 is illustrated. FIG. 8B illustrates a magnified view of the background patterned region 802 and the periodic circular patterned region 804 in the sheeting 800. The corner cubes in the periodic circular patterned region 804 are oriented differently from the orientation of corner cubes in the background pattered region 802 in the surface of the retro-reflective sheeting 800. If the corner cubes in the background patterned region 802 have a first orientation of zero degrees, the corner cubes in the periodic oriented patterned region 804 may have a second orientation of substantially ninety degrees or over a range of angles about ninety degrees, such as between eighty and one hundred degrees. The sheeting 800 does not include the sealing ring 717 that was found in the sheeting 700A-700B. FIG. 12A illustrate a magnified top view of the background corner cube patterned region with the first orientation separated by a circle from the periodic circular corner cube region with the second orientation.

Referring now to FIGS. 8B and 8C, a number of peaks and troughs are indicated along portions of a primary groove in the background patterned region 802 and over portions of primary grooves in the periodic oriented patterned region 804.

The corner cubes meet at troughs 710, 713, 720, 724, 728, 730, 732, and 738 along an axis in the periodic oriented patterned region 804 and the background patterned region 802 as shown in FIG. 8C. With a different orientation of substantially ninety degrees, the corner cubes meet at peaks 718, 722, 726, 729, 747, and 734 within the periodic oriented patterned region 804 along the same axis, while corner cubes meet at peaks 712, 714, 716, 736 off of the axis within the background patterned region 802. A circle 817, indicated at points 817A and 817B in FIG. 8C, separates the periodic oriented patterned regions 804 from the background patterned region 802.

In another embodiment of the invention, the master tool may be further modified to mill off the peaks of the corner cubes in the background pattern of corner cubes 312A in the top background patterned surface 312 and the circular regions of corner cubes 314A in the top orientable surface 314 of each rotatable button 304A. Replicants can be made from the master tool with the milled off peaks. Furthermore, retro-reflective sheeting can be made from the replicants to transfer the pattern of the master tool into a surface of the retro-reflective sheeting.

Referring now to FIG. 9, a cross sectional view (along the same axis shown in FIGS. 8B and 8C) a portion of a retro-reflective sheeting 900 is illustrated. A master tool with peaks of corner cubes cut or machined off was used to make replicants and pattern a top geometric optical surface in the flexible optical material substrate 950 (may also be referred to as a film due to its thinness) to form the retro-reflective sheeting 900. The peaks 718, 722, 726, 729, 747, and 734 of corner cubes within the periodic oriented patterned region 804 shown in FIG. 8C along the same axis have been flattened off to triangular surfaces 718′, 722′, 726′, 729′, 747′, and 734′ having a flat triangle-shaped area or cross section within the periodic oriented patterned region 904 shown in FIG. 9. The peaks 712, 714, 716, 736 of corner cubes within the background patterned region 802, shown in FIG. 8C off of the axis, have been flattened off to triangular surfaces 712′, 714′, 716′, and 736′ within the background patterned region 902 shown in FIG. 9. A circle (geometric shaped boundary) 817, indicated at points 817A and 817B in FIG. 9, separates the periodic oriented patterned regions 904 from the background patterned region 902. The plurality of periodic oriented patterned regions are spaced apart over the geometric optical surface. Each of the periodic oriented patterned regions 904 includes an array of corner cubes within a geometric shaped boundary having an orientation with respect to an edge of the retro-reflective sheeting. The background patterned region of corner cubes 902 surrounds each of the periodic oriented patterned regions 904 and has an orientation with the edge of the sheeting. The background patterned region differs from the plurality of periodic oriented patterned regions in retro-reflective performance by having the different orientation with respect to the edge of the sheeting or film, a different corner cube design with respect to the corner cube pattern, or both a different orientation and a different corner cube design. Retro-reflective sheeting manufactured with flat topped corner cubes from a top surface pattern design of a master tool with the same, may have an improved efficiency in retro-reflection of incident light of a given incident angle.

In the retro-reflective sheeting 700A,700B,800,900 of FIGS. 7A,7B,8A and 9, the facets of corner cubes in the background patterned region 702,802,902 have a first primary plane of retro-reflective performance. The facets of corner cubes in the periodic oriented patterned region 704,804,904 have a second primary plane of retro-reflective performance. With a different orientation between the background patterned region 702,802,902 and the periodic oriented patterned region 704,804,904 of substantially ninety degrees or over a range of angles about ninety degrees such as between eighty and one hundred degrees, the first primary plane of retro-reflective performance is substantially perpendicular (ninety degrees or over a range of angles about ninety degrees such as between eighty and one hundred degrees) to the second primary plane of retro-reflective performance. Primary planes of retro-reflective performance substantially perpendicular to each other are further described in U.S. Pat. No. 5,706,132 (Nestegard—Jan. 6, 1998); and U.S. Pat. No. 5,936,770 (Nestegard—Aug. 10, 1999); previously incorporated herein by reference.

The corner cubes have been shown as protruding from the film in some embodiments of the invention, in which case the corner cubes formed into the surface of the retro-reflective sheeting are male corner cubes. In other embodiments of the invention, the corner cubes formed in the surface of the retro-reflective sheeting are female corner cubes . In still other embodiments of the invention, the corner cubes formed in the surface of the retro-reflective sheeting are a combination of male corner cubes and female corner cubes.

### Design and Manufacture of Retro-Reflective Sheeting

The embodiments of the master tool described herein can be directly used to create stampers or replicant molds for the manufacture of retro-reflective sheeting. A desired pattern of corner cubes may be designed into the master tool that can be transferred to the optical plastic sheeting.

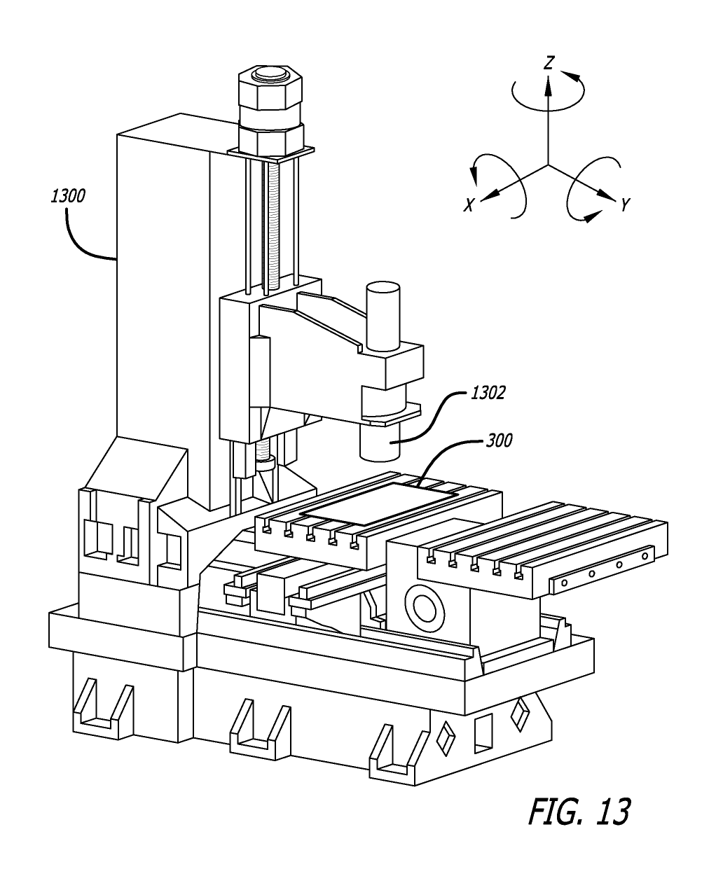

Referring now to FIG. 13, an exemplary computerized numeric cutting (CNC) machine 1300 is shown with six degrees of freedom to cut a pattern into the top surface of the master tool 300 including the background patterned surface 302 in the top surface of the top plate 302 and the orientable patterned surface 314 in each rotatable button 304. The exemplary CNC machine 1300 includes a diamond cutting head 1302 that can cut the desired pattern into the top surfaces of the master tool 300. With six degrees of freedom, the CNC machine 1300 and its diamond cutting head 1302 may cut a large number of patterns into the top surface of the master tool 300. In one embodiment of the invention, a corner cube pattern is cut into the top surfaces (surface 312 of the top plate 302 and orientable surface 314 of each of the rotatable buttons 304) of the master tool 300.

Generally, a pattern of corner cubes, prisms, pyramids, or other surface treatment pattern is formed into the top surface of the master tool by scribing, cutting, or micro-machining Corner cubes and other similar retro-reflector designs are formed in the surface of the master tool by means of a direct ruling technique with a diamond tool having two edges of the cutting face ground and polished on a diamond-charged lap so that the metal surfaces are optically flat and manifest specular reflectance with high efficiency. The diamond tool cuts three sets of V-shaped grooves, two cuts for each V-shaped groove. Alternatively, a pattern of corner cubes, prisms, pyramids, or other surface treatment pattern may be formed into the top surface of the master tool by indentation with a pin or other indenting tool.

By ruling the grooves in fairly soft metal (e.g., aluminum, copper or brass), which has been polished flat on one surface without causing the surface to be charged up with abrasive, capable of accentuating the wear of the diamond, the diamond tool imparts an optical polish to the walls of the grooves (faces of the pyramids), leaves the tips of the pyramids sharp, and does not leave burrs or rough edges at the intersections of the faces of the pyramids with one another. If a single diamond tool is used in a shaper-type ruling engine (one in which the tool is constrained to travel in a straight line, cutting on the forward stroke, lifted on the return stroke, with the work being translated at right angles thereto by pre-selected increments after the end of each cutting stroke), each groove requires as few as 5 and as many as 10 passes to obtain the desired depth. At this point, the die is finished, and no additional polishing of the faces of the pyramids is required. However, because the metal is soft, such a master die is usually not used to directly emboss a pattern into a sheeting. Thus, a suitable replication procedure is followed in order to obtain dies capable of producing corner cube cavities and corner cube prisms.

To form corner cubes, three series of V-shaped grooves angled apart from each other (e.g., sixty degrees apart) are inscribed into the top surface of the master tool. The V-shape that is inscribed into the surface may change from groove to groove to change the angles of the facets to cant the corner cube off of a perpendicular optical axis. Furthermore, the tops of the corner cubes may be lopped off such as by milling to provide a different retro-reflective structure in one embodiment of the invention. Additional details of embodiments of the master tool are described in U.S. Provisional Patent Application No. 61/311,088 entitled MASTER TOOLS AND PATTERNED SHEETING WITH PERIODIC ROTATED PATTERNED REGIONS filed on Mar. 5, 2010 by David Reed et al. previously incorporated herein by reference.

The master tool may be considered to be a male. A plurality of female replicant die may be formed from the master tool such as by an electroplating, electroforming, a metal vapor deposition, or other mold forming process. The plurality of female replicant die are then used to manufacture the plastic retro-reflective sheeting with a surface pattern having the desired pattern, such as corner-cube arrays.

Referring now to FIGS. 14A-14B, an exemplary simplified method of forming a female replicant die 1430 from a master tool 300 is shown. The master tool 300 with the top surface patterns in the top plate is placed into an electroplating bath 1400. The master tool 300 is charged so that metal is attracted to and formed over its top surfaces to form the replicant 1430 as shown in FIG. 14A. The charge is removed and the replicant 1430 is then separated from the master tool 300 and removed from electroplating bath 1400 as shown in FIG. 14B. The process can be repeated additional times to form a plurality of replicants 1430, each having a negative of the top surface pattern in the master tool. The replicants 1430 may be used in a stamping, embossing, or a molding process to manufacture retro-reflective sheeting. Further exemplary methods that may be used to form replicants, die, or molds of a surface of a master tool are generally described in U.S. Pat. No. 2,232,551 (Merton—Feb. 18, 1941); U.S. Pat. No. 2,464,738 (White—Mar. 15, 1949); U.S. Pat. No. 2,501,563 (Colbert—Mar. 21, 1950); U.S. Pat. No. 3,548,041 (Steding—Dec. 15, 1970); and U.S. Pat. N. 4,633,567 (Montalbano—Jan. 6, 1987); all of which are hereby incorporated by reference.

Referring now to FIG. 15, a plurality of replicants (also referred to as replicas or replicates) 1430 may be tiled and assembled together as part of a belt 1500. The belt 1500 that may be rotated about one or more spools, pulleys. or rollers and pressed against a warm optical plastic to form a patterned surface into retro-reflective sheeting 700A,700B,800,900 in a continuous fashion. The replicants may be flexible so that they can be rotated about the one or more spools, pulleys. or rollers and return or spring back into shape while transferring their surface pattern to sheeting. A surface of uncured, soft semi-solid or semi-liquid optical material is embossed with the desired surface pattern by the loop of replicants 1430, allowed to cool and cure with the desired surface pattern, and then separated from the replicants. Examples of embossing machines and processes that may be used for manufacturing retro-reflective sheeting are generally described in U.S. Pat. No. 2,849,752 (Leary—Sep. 2, 1958) and U.S. Pat. No. 4,244,683 (Rowland—Jan. 13, 1981) which are both hereby incorporated by reference.

Referring now to FIG. 16, an exemplary schematic diagram of a manufacturing system 1600 is illustrated. A plurality of replicants 1430 may be assembled together about a drum 1602 in the manufacturing system 1600. The manufacturing system 1600 receives as an input a plurality of pellets, beads, pulverized, or chunks of an optical plastic that may be heated or melted into a liquid optical plastic 1604. An extruder may extrude the liquid optical plastic in order to form a roll of retro-reflective sheeting at the output of the system. The liquid optical plastic 1604 may be poured into the replicants 1430 about the drum to form retro-reflective sheeting. Rollers may be used to cool down the patterned sheeting to a more solid state. A backing or other layers may spooled off from a spool 1610 and mated with the retro-reflective sheeting and then taken in and wound about a wind up roller or spool 1612. The manufacturing system 1600 continuously manufactures retro-reflective sheeting to make a complete roll of retro-reflective sheeting. Examples of other molding machines and processes that may be used for manufacturing retro-reflective sheeting are generally described in U.S. Pat. No. 3,689,346 (Rowland—Sep. 5, 1972) and U.S. Pat. No. 3,811,983 (Rowland—May 21, 1974) which are both hereby incorporated by reference.

The exemplary manufacturing system 1600 may have one or more flows of molten or liquefied material that can be combined together for multiple layers of the retro-reflective sheeting. A laminating machine may be used to laminate multiple layers of materials together including a retro-reflective layer. In another case, a vacuum former may be used to apply additional material layers to the retro-reflective layer.

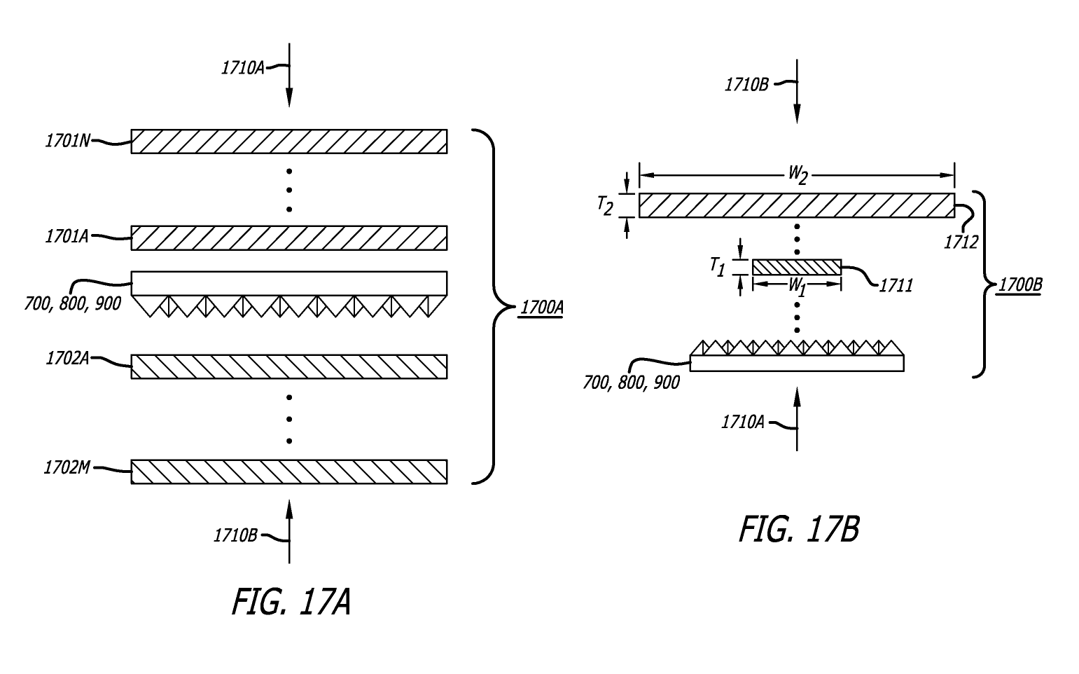

Referring now to FIGS. 17A-17B, the retro-reflective film 700,800,900 may be laminated with other layers of materials depending upon the desired application to form a retro-reflective laminate sheeting. Typically, at least one layer 1702A is coupled over the optical microstructures formed in the surface of the retro-reflective film 700,800,900 to protect them from damage, moisture, etc. that may interfere with their optical or retro-reflective efficiency. The optical microstructures formed in the surface of the retro-reflective film 700,800,900, such as corner cubes, may be formed therein to reflect light which is incident from a front side of the optical microstructures or from a back side of the optical microstructures.

In FIG. 17A, incident light rays 1710A may be coupled into the back side of the optical microstructures in the retro-reflective layer 700,800,900 of the retro-reflective laminate sheeting 1700A to reflect light back out of the back side. Alternatively, incident light rays 1710B may be coupled into the front side of the optical microstructures in the retro-reflective layer 700,800,900 of the retro-reflective laminate sheeting 1700A to reflect light back out of the front side.

In FIG. 17B, incident light rays 1710A may be coupled into the back side of the optical microstructures in the retro-reflective layer 700,800,900 of the retro-reflective laminate sheeting 1700A to reflect light back out of the back side. Alternatively, incident light rays 1710B may be coupled into the front side of the optical microstructures in the retro-reflective layer 700,800,900 of the retro-reflective laminated sheeting 1700B to reflect light back out of the front side.

FIG. 17A further illustrates that one or more layers of other materials may be laminated on either or both top and bottom of the retro-reflective layer 700,800,900. The one or more layers 1701A-1701N may be laminated together with the retro-reflective layer 700,800,900 on a first surface. The one or more layers 1702A-1702N may be laminated together with the retro-reflective layer 700,800,900 on a second surface opposite the first surface. The one or more layers 1702A-1702N cover over the optical microstructures formed in the surface of the retro-reflective film 700,800,900 to protect them from damage, moisture, etc. that may interfere with their optical or retro-reflective efficiency. Either the one or more layers 1701A-1701N, the one or more material layers 1702A-1702N, or both may be transparent over a desired range of wavelengths to allow light of desired wavelengths to pass through or filter out undesired wavelengths of electromagnetic radiation.

FIG. 17B further illustrates the one or more layers of other materials, which may be laminated together with the retro-reflective layer 700,800,900, may have various widths and various thicknesses. For example, layer 1711 has a width W1 and a thickness T1. Layer 1712 has a width W2 and a thickness T2 each differing respectively from the width W1 and the thickness T1 of layer 1711, for example. The lengths of the layers may also vary along the laminated film. Furthermore, the widths, thicknesses, and lengths of other material layers may not be uniform across the retro-reflective layer 700,800,900.

The differing widths and lengths may be used to alter the reflectivity efficiency to display lettering, for example, or alter the color or frequency of the reflected light back towards a source, for example. The differing thicknesses may similarly be used to alter the reflectivity efficiency or may be related to the amount of material needed to provide a desired effect.

The type of material used to form the retro-reflective sheet 700,800,900 may alter the reflectivity efficiency of the retro-reflective laminate. The type of the other materials, their index of refraction, and position with respect to the optical microstructures, may also alter the reflectivity efficiency of any retro-reflective laminate. Furthermore, the reflectivity efficiency can be maximized for some frequencies or colors of light and minimized for other frequencies or colors of light by appropriate selection of the other layers of material, their thicknesses, and dimensions. Some of the other material layers may be transparent or opaque to certain desired wavelengths or frequencies of light and not others.

The retro-reflective sheet layer 700,800,900 may be a polymer or plastic layer such as a thermoplastic or other material layer having optical properties that can have an optical pattern formed into a surface. In one embodiment, the retro-reflective sheet layer 700,800,900 is a transparent semicrystalline polymer.

Examples of the types of other material layers that may be laminated together with the retro-reflective layer 700,800,900 are a reflective film coating, color pigments, ink, phosphor, silica, polarizer, sealant, protective coating, binder, substrate, adhesive, and removable release sheet layer. The adhesive layer may be a pressure sensitive adhesive, a heat activated adhesive, or a radiation activated adhesive. The removable release sheet layer may be used to protect the adhesive layer until the reflective laminate is ready to be coupled to a surface.

The silica (silicon-di-oxide) may be used to fill into voids formed by the optical microstructures into an even level surface. One form of silica that may be used is mica. Other material may be used to fill into the v-shaped grooves and other voids of retro-reflective sheeting to enhance the performance or avoid degradation of the performance of retry-reflective sheeting.

The protective coating layer may be provided to resist abrasion and stains such as may be experienced by tires running over a pavement marker. The protective coating layer may also provide soil and dew repellency to maintain the original reflectivity efficiency of the laminate after exposure to moisture and dirt or grime.

A substrate may be provided to fix the reflexive laminate to a surface by mechanical means, such as by sewing into a garment or shoe. The binder layer or adhesive layer may be provided to affix the retro-reflective laminate to a surface.

A reflective film, such as a metal foil formed of a thin layer of aluminum, brass, copper, gold, nickel, platinum, silver, or titanium may also be used to reflect light and/or provide a difference in index of refraction. The reflective film may be laminated or alternately sprayed onto the retro-reflective layer 700,800,900. Other materials that may be used to form a retro-reflective film layer such as titania, zirconia, cobalt/iron mixture, zirconia-di-oxide, zinc oxide, white lead, antimony oxide, zinc sulfide, alumina and magnesia.

The other layers may also be multiple alternating layers of two polymers each with a thickness less than one hundred nanometers, selected to have a mismatch in refractive indices to cause constructive interference of light.

The layers may be laminated together by pressure and heating in the extrusion process. Alternatively and/or conjunctively, the layers may be laminated together by pressure and the use of a thin layer of glue, binder, or epoxy selectively used between the layers to hold multiple layers together.

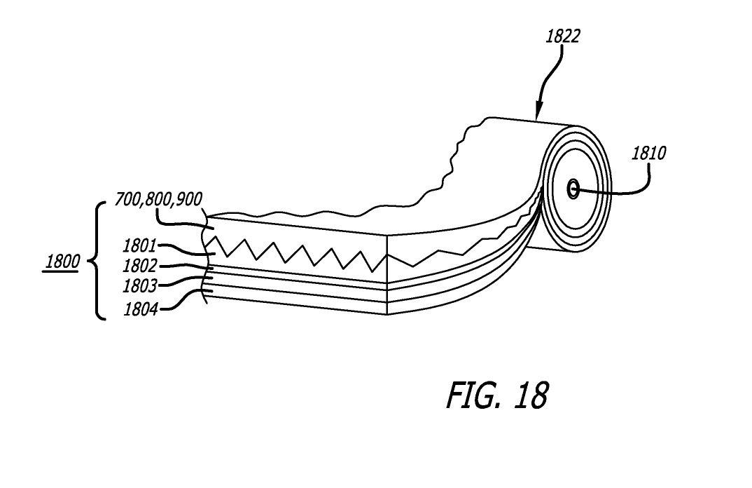

Referring now to FIG. 18, a roll 1822 including the retro-reflective sheeting 700,800,900 is illustrated. As previously discussed other layers of materials may be laminated around the retro-reflective sheeting 700,800,900 to form a retro-reflective laminate 1800. The retro-reflective laminate includes the retro-reflective sheeting 700,800,900 and one or more other layers of other materials, such as layers 1801-1804 for example. As previously discussed and illustrated in FIGS. 17A-17B, the one or more layers of other materials may be sized differently and located on either side of the retro-reflective sheeting.

Thus, the roll 1822 may be a roll of retro-reflective sheeting 700,800,900 alone, without other layers. Alternatively the roll 1822 may be a roll of a retro-reflective laminate 1800 including other layers laminated together with the retro-reflective sheeting 700,800,900. The roll 1822 may further include a center cylinder core 1810 upon which the retro-reflective sheeting 700,800,900 or retro-reflective laminate 1800 may be spiral wound. The center cylinder core 1810 may be a spool including edges to align the retro-reflective sheeting 700,800,900 or retro-reflective laminate 1800 as its wound around by the wide up roller.

The retro-reflective film 700,800,900 can be used in a broad range of reflector applications including but not limited to reflective signage, pavement markers, sportswear, and safety clothing. Reflectors and retro-reflective film can be incorporated into articles of manufacture in a number of ways. The reflector can be formed as a part of the article, such as in a spoke reflector for a bicycle or a tail reflector for a vehicle. Alternatively, the reflector can be formed into a sheet or a strip of material layers and then applied or coupled to the article. Retro-reflective tape can be applied to clothing, for example. Retro-reflective sheeting or film may be applied to highway signage or markers. The retro-reflective film 700,800,900 or retro-reflective laminate may be spooled or wound off of the roll 1822 and applied to the article during manufacturing.

### Conclusion

The embodiments of the invention facilitate a cost effective method of master tool fabrication. The embodiments of the invention provide freedom to design a wide variety of corner cube elements of different canting angles, orientations and area fractions into a surface. The embodiments of the invention facilitate the design of an integral seal pattern in retro-reflective sheeting.

While certain exemplary embodiments of the invention have been described and shown in the accompanying drawings, it is to be understood that such embodiments are merely illustrative of and not restrictive, and that the embodiments of the invention not be limited to the specific constructions and arrangements shown and described, since various other modifications may become apparent after reading this disclosure. For example, the master tool is described herein as being used to design and manufacture a corner cube pattern into a retro-reflective film or sheet. However, the master tool may also be used to form other types of structures or microstructures in the surface of a film or sheet of material. Rather than limiting the embodiments of the invention to the specific constructions and arrangements shown and described herein, the invention should be construed according to the following claims.

What is claimed is:

1. A retro-reflective sheeting comprising:
a flexible optical material film having a geometric optical surface opposite a base surface, the geometric optical surface including
a background pattern region of corner cubes arranged at a first orientation with respect to an edge of the retro-reflective sheeting;
an array of circular corner cube regions periodically interrupting the background pattern region of corner cubes, each of the circular corner cube regions having a second orientation with respect to the edge of the retro-reflective sheeting; and
wherein the array of the plurality of circular corner cube regions to reflect incident light differently than the background pattern region of corner cubes.

2. The retro-reflective sheeting of claim 1, wherein
a corner cube pattern in each of the circular corner cube regions differs from a corner cube pattern in the background pattern region of corner cubes such that the plurality of circular corner cube regions reflect incident light differently than the background pattern region of corner cubes.

3. The retro-reflective sheeting of claim 2, wherein
the corner cube pattern in each of the circular corner cube regions is a diamond pattern, and
the corner cube pattern in the background region is a prismatic pattern.

4. The retro-reflective sheeting of claim 1, wherein
the second orientation of each of the circular corner cube regions differs from the first orientation of the background pattern region of corner cubes such that the plurality of circular corner cube regions reflect incident light differently than the background pattern region of corner cubes.

5. The retro-reflective sheeting of claim 4, wherein
the second orientation is parallel to the edge of the retro-reflective sheeting such that a primary groove of the corner cubes in the circular corner cube regions are parallel to the edge of the retro-reflective sheeting, and
the first orientation is perpendicular to the edge of the retro-reflective sheeting such that a primary groove of the corner cubes in the background pattern region are perpendicular to the edge of the retro-reflective sheeting.

6. The retro-reflective sheeting of claim 1, wherein the geometric optical surface in the flexible optical material film further includes
a sealing ring around each of the circular corner cube regions, the sealing ring having a top surface with a height greater than a first peak height of corner cubes in the background pattern region and a second peak of corner cubes in the circular corner cube regions.

7. The retro-reflective sheeting of claim 1, wherein
the background pattern region of corner cubes and the array of circular corner cube regions form a tiled master pattern that is substantially repeated in the geometric optical surface across a width and along a length of the retro-reflective sheeting.

8. The retro-reflective sheeting of claim 7, wherein
the tiled master pattern is diamond shaped such that the background pattern region therein is diamond shaped, and
the array of circular corner cube regions is spaced out in a periodic pattern within the diamond shape of the background pattern region.

9. The retro-reflective sheeting of claim 7, wherein
the tiled master pattern is rectangularly shaped such that the background pattern region therein is rectangularly shaped, and
the array of circular corner cube regions is spaced out in a periodic pattern within the rectangular shape of the background pattern region.

10. The retro-reflective sheeting of claim 7, wherein
the tiled master pattern is square shaped such that the background pattern region therein is square shaped, and
the array of circular corner cube regions is spaced out in a periodic pattern within the square shape of the background pattern region.

11. A retro-reflective sheeting comprising:
an optical material film having a top surface opposite a base surface, the top surface including a plurality of tiles arranged together each having
a plurality of periodic oriented patterned regions spaced apart over the optical surface, each of the periodic oriented patterned regions includes an array of corner cubes within a geometric shaped boundary having an orientation with respect to an edge of the retro-reflective sheeting;
a background patterned region of corner cubes surrounding each of the periodic oriented patterned regions, the background patterned region differs from the plurality of periodic oriented patterned regions; and
wherein the plurality of periodic oriented patterned regions reflect incident light differently than the background pattern region of corner cubes.

12. The retro-reflective sheeting of claim 11, wherein
the background patterned region differs from the plurality of periodic oriented patterned regions in that an orientation of the corner cubes in the background patterned region are arranged at a second orientation with respect to the edge of the retro-reflective sheeting that differs from the orientation of the array of corner cubes in each of the periodic oriented patterned regions.

13. The retro-reflective sheeting of claim 11, wherein
the background patterned region differs from the plurality of periodic oriented patterned regions in that the corner cubes in the background patterned region are shaped differently than the array of corner cubes in each of the periodic oriented patterned regions.

14. The retro-reflective sheeting of claim 13, wherein
the corner cubes in the background patterned region are canted at a first angle of cantation and the array of corner cubes in each of the periodic oriented patterned regions are canted at a second angle of cantation differing from the first angle of cantation.

15. The retro-reflective sheeting of claim 14, wherein
the background patterned region differs from the plurality of periodic oriented patterned regions in that an orientation of the corner cubes in the background patterned region are arranged at a second orientation with respect to the edge of the retro-reflective sheeting that differs from the orientation of the array of corner cubes in each of the periodic oriented patterned regions.

16. The retro-reflective sheeting of claim 15, wherein
a difference in the orientation of the corner cubes in the background patterned region and the orientation of the array of corner cubes in each of the periodic oriented patterned regions is ninety (90) degrees.

17. The retro-reflective sheeting of claim 11, wherein
each tile is rectangularly shaped such that the background patterned region is rectangularly shaped.

18. The retro-reflective sheeting of claim 11, wherein
each tile is diamond shaped such that the background patterned region is diamond shaped.

19. The retro-reflective sheeting of claim 11, wherein
each tile has a geometric shape such that the background patterned region has the geometric shape; and
a boundary of each of the plurality of periodic oriented patterned regions has a geometric shape of a circle or a regular polygon that is equiangular and equilateral.

20. The retro-reflective sheeting of claim 11, wherein
the corner cubes in the background patterned region and the array of corner cubes in each of the periodic oriented patterned regions have their peaks cut off.

21. The retro-reflective sheeting of claim 11, wherein each of the plurality of tiles arranged together further has
a raised perimeter wall structure around each of the periodic oriented patterned regions between the background patterned region and the periodic oriented patterned regions, the raised perimeter wall structure having a top surface with a height greater than a first peak height of corner cubes in the background patterned region and a second peak height of corner cubes in the periodic oriented patterned regions.

22. The retro-reflective sheeting of claim 21, wherein
the raised perimeter wall structure is a circular ring that avoids linear edges to provide an overall retro-reflector pattern that is more agreeable to human eyes.

23. The retro-reflective sheeting of claim 11, wherein
the geometric shaped boundary is a circle that avoids linear edges to provide an overall retro-reflector pattern that is more agreeable to human eyes.

24. The retro-reflective sheeting of claim 11, further comprising:
a layer with printed letters, numbers, and/or symbols is coupled to the optical material film, and
wherein the geometric shaped boundary is a circle that avoids linear edges such that portions of the printed letters, numbers, and/or symbols overlap portions of the circle so that the printed letters, numbers, and/or symbols are more legible to human eyes.

25. The retro-reflective sheeting of claim 11, wherein
the plurality of periodic oriented patterned regions reflect incident light at the given angle of incidence with a different efficiency than the background pattern region of corner cubes.

26. A method for retro-reflective sheeting, the method comprising:
repositioning an array of buttons within a top plate of a master tool to position an orientable patterned surface of each button at a different orientation to that of a background patterned surface to form a top patterned surface of the master tool;
forming a plurality of replicants of the top patterned surface of the master tool;
tiling the plurality of replicants together; and
coupling an optical material to the plurality of replicants to transfer and replicate the top patterned surface of the master tool across a surface of the retro-reflective sheeting.

27. The method of claim 26, further comprising:
prior to repositioning the array of buttons, cutting a uniform corner-cube pattern into top surfaces of the top plate and the array of buttons to respectively form the background patterned surface and the orientable patterned surface into each button.

28. The method of claim 27, further comprising:
prior to repositioning the array of buttons,
cutting off the peaks of the corner cubes in the background patterned region, and in each of the periodic oriented patterned regions.

29. The method of claim 26, further comprising:
prior to repositioning the array of buttons, cutting a first corner-cube pattern into a top surface of the top plate and a second corner-cube pattern differing from the first corner-cube pattern into a top surface of the array of buttons to respectively form the background patterned surface and the orientable patterned surface into each button.

30. The method of claim 26, wherein
the plurality of replicants are tiled together on a belt in a loop to couple to the flexible optical material.

31. The method of claim 26, wherein
the plurality of replicants are tiled together around a drum in a loop to couple to the flexible optical material.
